(19) United States
(12) Patent Application Publication
(10) Pub. No.: US 2011/0304114 A1
(43) Pub. Date: Dec. 15, 2011

(54) CONFIGURABLE CARGO SYSTEM FOR A PICK-UP TRUCK

(76) Inventor: JAY ANTON SPANJERS, Brooklyn Park, MN (US)

(21) Appl. No.: 13/069,382

(22) Filed: Mar. 23, 2011

Related U.S. Application Data
(60) Provisional application No. 61/316,786, filed on Mar. 23, 2010.

(51) Int. Cl. B62D 61/00; B62D 33/00

(52) U.S. Cl. 280/63; 296/182.1

(57) ABSTRACT

A convertible and configurable cargo system for integration with pick up bed (or truck chassis): a bed rail assembly, support joists, jacks, and cargo deck. The cargo assembly frame consists of longitudinal supports and transverse joists. It has attachable wheels for rolling cargo in and out of the truck bed. With trailer tongue attachment it also serves as a utility trailer. The cargo deck is comprised of removable panels that are installed on the support joists that also may provide channels for carrying water away from the truck bed below. The removable panels are further covered with an elastomeric material to provide weather protection. For the removal of items in the bed of the truck, the panels have lift up doors with waterproof seals.

### CROSS-REFERENCE TO RELATED APPLICATIONS

This application claims the benefit of Provisional Application Ser. No. 61/316,786, Filed On 23 Mar. 2010, which is hereby incorporated by reference herein in its entirety.

### FIELD OF INVENTION

This invention relates to truck accessories, accessories for a trailer and more particularly to cargo systems for interfacing with the chassis of a truck or trailer.

### BACKGROUND

Since the introduction of the pickup truck with its open bed, tailgate and sidewalls there has been myriad products produced to take advantage of the cargo carrying capability. These products range from full size camping toppers complete with installed appliances to tool boxes for construction crews, to gas tanks that can be used to fill tractors and construction machinery, and ladder racks of all shapes and sizes. Another accessory that has many variants is the bed cover that protects the contents of the bed from the elements. These range from the sheet metal “topper” that extends the full length of the pick-up bed horizontally and vertically that are approximately or slightly higher than the top of the cab, to covers that are fabricated from sheet metal or cloth that are flush with the top of the bed. All these products have merit for a limited range of applications, but are not designed to be configurable for a large range of applications, particularly for carrying a load.

### BRIEF DESCRIPTION OF THE INVENTION

The configurable cargo system described herein and depicted in the included figures may be secured to the bedrails of a pick-up truck, or the chassis of a truck, and includes cargo deck frame assembly for supporting a cargo deck. Accordingly, the cargo deck frame assembly is configured and mounted to the truck frame so as to provide an enclosed cargo space beneath the cargo deck that is protected from the environment.

In accordance with the present invention, the deck is provided by way of a plurality of solid deck panels. In accordance with one aspect of the present invention, each of the panels may be provided with an upper surface coated with a waterproof material. One example of such a waterproof material is EPDM rubber (or elastomeric) which is waterproof, UV resistant, skid proof, readily available and easy to maintain. The solid deck material may be covered with EPDM recycled from discarded rubber roof membrane, sprayed on truck bed lining, or other liquid applied membranes.

In another aspect of the present invention. as will more fully described, the cargo deck assembly may be arranged within a truck bed so that it may be tilted front-to-back or visa versa, or left-to right or visa versa, so as to affect the center of gravity and stability of selected loads by way of four (4) jacks secured to the cargo deck structure, and are each preferably adjustable jacks. Because the deck of the “topper” lowers it can carry keep the center of gravity (thereby providing greater stability and safety) when carrying a heavy load. With the front tilted towards the front of the truck sheets of plywood will ride easier with reduced likelihood of flying out. With it tilted to one side or the other, pipes and other items that roll ride more static. With the bed tilted towards the tailgate loose loads (dirt, gravel) can more easily be unloaded. With the decking flush with the sides of the truck it produces a clean sleek look and less wind resistance.

The cargo deck assembly in accordance with the present invention is constructed to avoid or minimize water leaks into the tuck bed below the cargo deck ensuing from inclement weather of snow and rain. In accordance with the present invention the cargo deck assembly when installed provides a guttering system as depicted in the drawings that channels water to the sump holes in the front corners of the truck bed and the hinge space of the tailgate. Parts of this water channeling system maybe provided by EPDM or other flexible material that is attached with a micro hook and loop material that can be disconnected and used as a fender guard when placed over the bed rail of the truck while loading ding and unloading items and materials that could damage the truck's finish. A flap of EPDM or similar waterproof membrane, is hung from the rear transverse support to the crack in tailgate hinge to direct water coming off of the cargo deck away from inside of truck box out the crack in the tail gate hinge area.

The configurable cargo deck system in accordance with the present invention includes many inherent features by way of its configurable and flexible design as recited below including:
(i) For additional load capacity, a removable longitudinal member and adjustable jacks under the decking frame, provides support.
(ii) The framework provides many possibilities for tie-down straps, cables or chains.
(iii) Hard surface toppers typically need to be removed when hauling large or bulky items like furniture. Simply removing some of the panels often provides enough space for the large item. A very large item would require slight loosening 2 to 6 bolts (depending on the size of the truck and the item carried) and sliding the uni-struts out of the way.
(iv) The deck panels can be stored on top of one another therefore leaving a majority of the bed or trailer open for conventional use and avoiding the necessity of finding a place to put them and requiring another trip to retrieve them as you would a regular hard surface cover.
(v) Advantages of the current invention are that even with cargo loaded on the cargo deck, if the cargo does not completely cover the deck, the interior of the bed can be accessed by raising one of the cargo panels. The EPDM (elastomeric) cover can be stretched over the bed of a pick-up truck say, or cargo loaded on the cargo deck. This not only protects cargo from the environment, in the case where it is stretched over cargo on the cargo deck, it helps restrain the cargo from movement due to mechanical inputs from the vehicle chassis.
(vi) Finally, with cargo deck removed, and EPDM (elastomeric) cover stretched over bed, cargo can be placed on top of cover, and the “pocket” formed due to the weight of the cargo will help retain cargo in this resting position.
(vii)The storage access doors provide needed security from theft and malice. They utilize EPDM as a hinge with supports for additional security and can be a continuous hinge or other hinging system. The doors are weather tight and lockable. The locking system uses a sliding bar on each side accessible when the tailgate is lowered. When a bar is pulled to the rear of the truck it releases all the tabs on the doors on that side. When the bar is pushed towards the front of the truck it engages tabs on all the doors on that side with one movement.
(viii) A large and frequent objection consumers have about this type of product is the difficulty and danger to self and property. With the bed extender in use and the bed tilted the steep angle required is greatly reduced

In accordance with the present invention, a trailer wheel assembly may be easily secured to the cargo deck assembly a channel locking assembly. Once arriving at one's destination with an ATV and a truck full of supplies for a weekend camping, fishing, hunting or other excursion, the cargo deck assembly, with wheels attached, may be used as a utility trailer carrying all the gear. Also, another feature by way of the adjustable jacks already in place permits the trailer to be leveled and become a platform for a temporary shelter such as a tent, fish house or “pop-up” shelter.

A feature that makes this device even more adaptable to unique uses is a self storing “bed extender”. When extended with additional panel installed, it serves as a ramp that goes to the level of the tailgate for a continuous low slope for easier and safer loading and off-loading. In the horizontal position it provides additional length for hauling over-length loads like snowmobiles.

### DESCRIPTION OF THE DRAWINGS

FIG. 1 is a perspective view of one embodiment of a configurable cargo system in accordance with the present invention.

FIG. 2 is another perspective view of one embodiment of a configurable cargo system in accordance with the present invention.

FIG. 3 illustrates a side view perspective of FIG. 1.

FIG. 4 shows the configurable cargo system without a load on the deck, and illustrates that deck panels 13 and 14 can be used as doors.

FIG. 5 shows a cargo deck with consisting of a plurality of panels.

FIG. 6 illustrates construction detail.

FIG. 7 shows another perspective view jacks adjusted for back-to-front tilt.

FIG. 8 shows an example of an adjustable jack and mounting to the cargo assembly.

FIG. 9 is another perspective view from the rear of a truck bed.

FIG. 10-14 illustrates construction detail.

FIG. 15-18 illustrates a trailer wheel assembly and construction detail secured to the cargo deck assembly.

FIGS. 103-105 and 103B-105B illustrates further construction details particularly the gasket detail.

FIG. A1-A70 illustrates construction details of the configurable cargo system of the present invention, particularly the system including the wheel assembly mounted to the cargo deck assembly structure and gutter system.

FIG. A50, A53-A54 illustrates the cargo bed assembly (panels removed) with rearward mounted trailer wheel assembly, and forward mounted trailer towing hitch assembly.

FIGS. A55, A56, and A57 illustrates the flexible gutter secured the truck at one end and other end secured to the cargo assembly by way of hook-and-loop.

FIG. A58 illustrates the louvered panels, one being open for access to the cargo bed beneath the panel assembly.

FIGS. A59-A66 illustrates the bed extender in accordance with the present invention.

FIGS. A67-A60 illustrates the easily adaptable attachment of the wheel assembly byway of a channel lock and bolt assembly.

FIG. 431 illustrates the cargo bed extender in accordance with the present invention.

FIG. 432 illustrates a rear view of the truck bed with the cargo bed assembly installed.

FIGS. 433-434 are omitted.

FIG. 435 illustrates a rear view of the truck bed with the cargo bed assembly installed and beneath the assembly depicting the attached wheel assembly.

FIG. 436 is omitted.

FIG. 437 illustrates a rear end view of the novel side gutter assembly.

FIG. 438 illustrates a metal channel unistrut.

FIGS. 439-440 further illustrate construct details of the bed extender.

FIG. 441 is omitted.

FIG. 442 illustrates the cargo door in an open position exposing details of the wheel assembly and supporting structure.

FIG. 443 illustrates further details of the wheel assembly and support structure.

FIG. 444 illustrates further details of the support structure.

FIG. 445 is omitted.

FIG. 446 illustrates a closed cargo assembly.

FIGS. 447-448 illustrate an end view of the cargo assembly structure height adjustment jack and gutter assembly.

FIGS. 449-451 illustrate the cargo assembly off the truck and supported by the wheel assembly.

FIG. 452 illustrates the cargo assembly off the truck and supported by the wheel assembly with load panels in place.

FIGS. 453-477 are omitted.

FIGS. 477-478 illustrate the cargo assembly lowered in position for receiving an ATV driven up the cargo ramps.

FIGS. 479-483 are omitted

FIGS. 484-486 illustrate the bed extender from a side view and end view respectively.

### DETAILED DESCRIPTION

In the following detailed description, reference is made to the accompanying drawings which form a part hereof, and in which is shown by illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

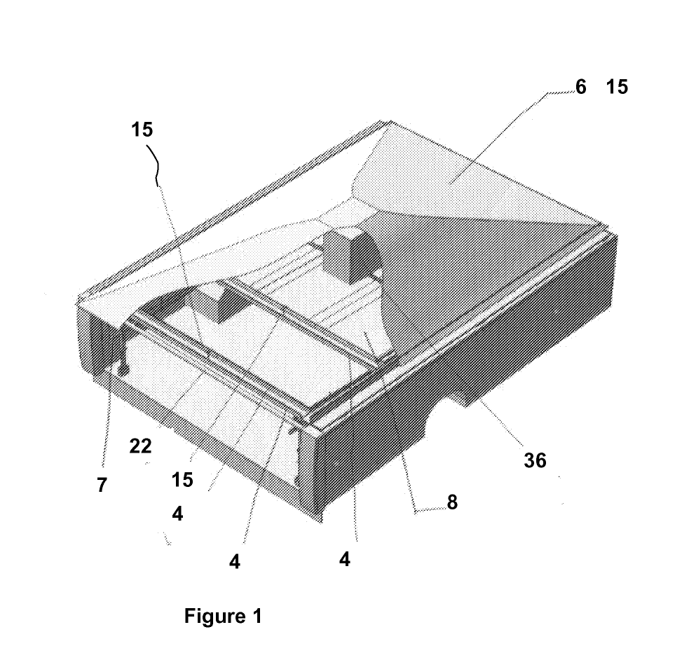

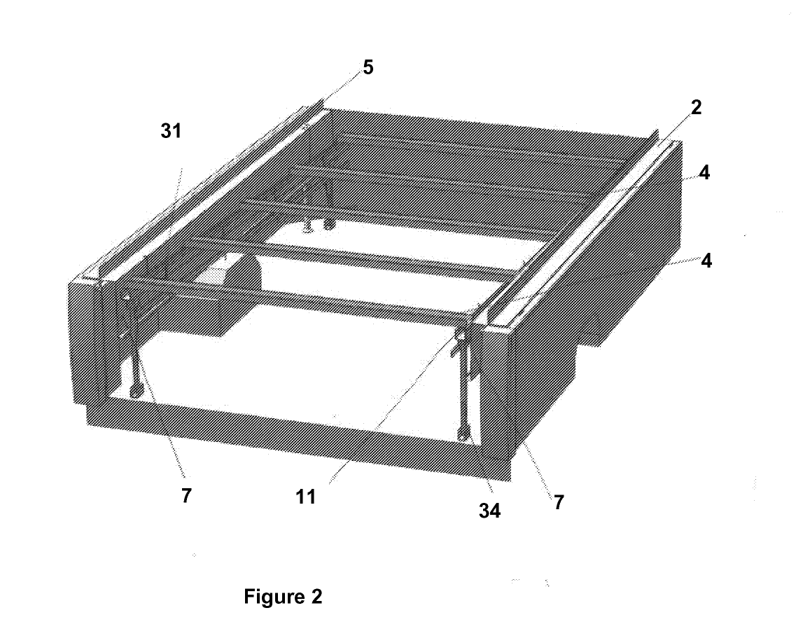

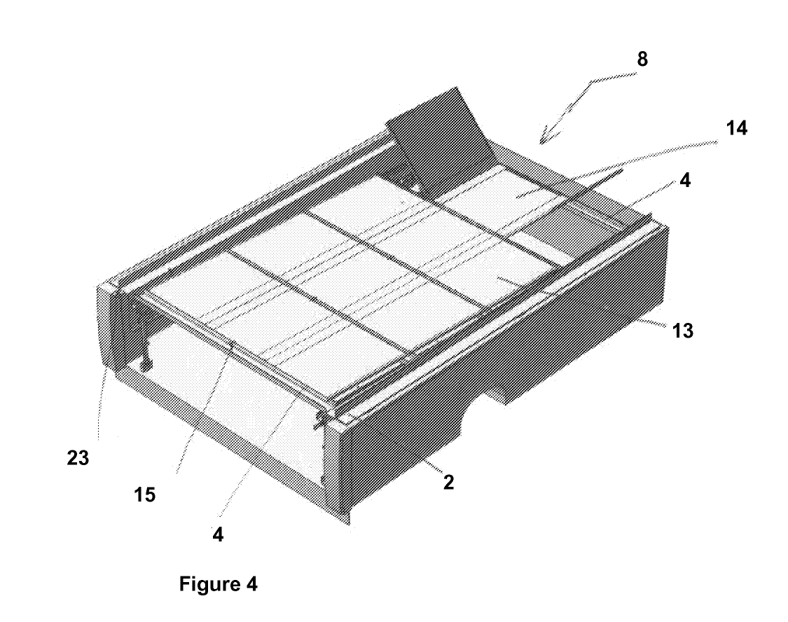

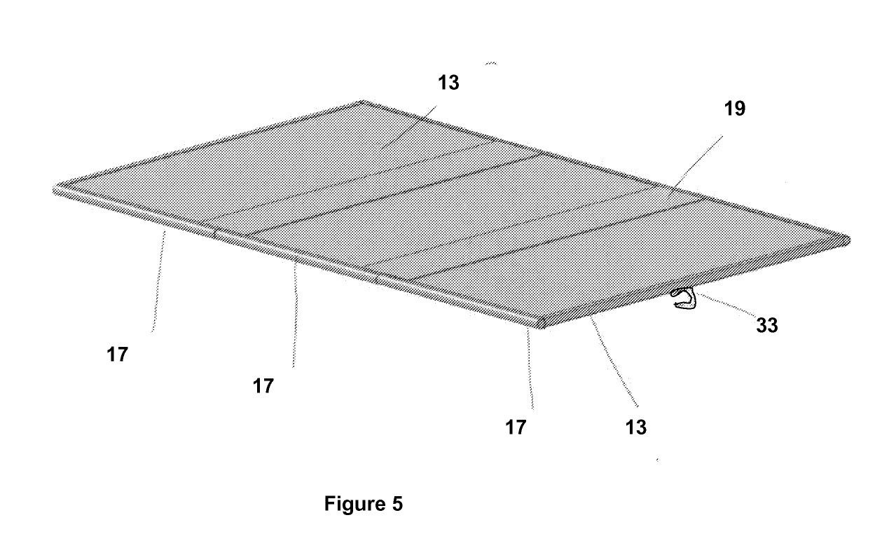

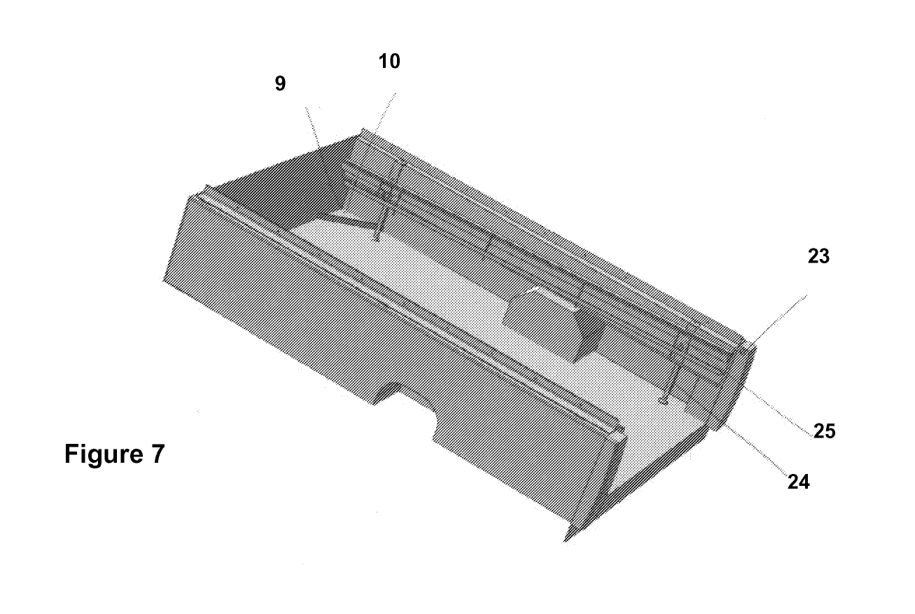

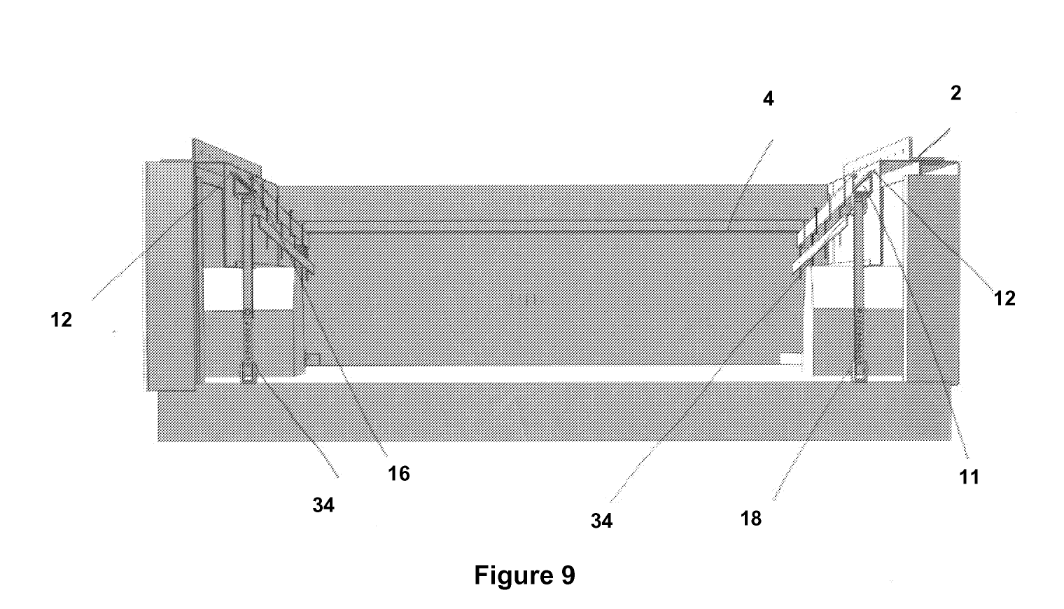

FIG. 1 is a perspective view of a configurable cargo system according to one embodiment. FIG. 4 shows the configurable cargo system without a load on the deck, and illustrates that deck panels 13 and 14 can be used as doors. It also shows deck panels 13 and 14 in inclined position. Configurable cargo system includes a longitudinal bed rail assembly 2 that is rigidly attached to the chassis of the truck and typically matches the length of the bed rail of the truck. Bed rail assembly may be attached to truck's bed rail by use of threaded fasteners, clamps, anchors installed in stake pockets of truck's bed rail, or even adhesives or welding. This assembly can be welded or extruded and functions as a: mounting flange 2 that allows attachment to bed rail, a tie down rail 5 that acts as a tie down point for cargo straps or other securing device through the use of holes for hooks for example, an edge for hooks on EPDM cover 6 to clasp to, and it also serves as transverse stop for deck panels 13 and 14 when the cargo deck 8 is at its' maximum elevation. FIG. 2 is a perspective view with several components removed for greater clarity. The bedrail assembly also has a secondary leakage channel 7 that runs the length of the bed. This secondary leakage channel captures any fluid leakage past the primary seal 12 that is affixed to the longitudinal channel 11. This can also be seen in FIG. 9. This secondary channel 7 could be formed of sheet metal including but not limited to steel, aluminum or copper. It could also be molded of plastic or fabricated from a composite material. This secondary channel 7 or “gutter” also acts as a bearing surface for the seal that is attached to the support beam that runs longitudinally with the bed rail. The seal 12 could be made from an elastomeric material and attached to the longitudinal channel 11 with adhesive, or could be made of a material such as sheet metal and affixed to the longitudinal channel 11 by means threaded fasteners, adhesive, or welding. The seal 12 acts primarily to divert fluid that leaks past deck panels 13 and 14 into the longitudinal channels 11 which then directs fluid into sump 9 (FIG. 7) or tailgate area of bed. Once there, fluid can leak out of drain hole 10 in the sump 9 or gap between tailgate and bed. Longitudinal channels 11 also serve as the connection points for transverse support joists 4, and sump in the front part of the bed, or the tailgate area for draining.

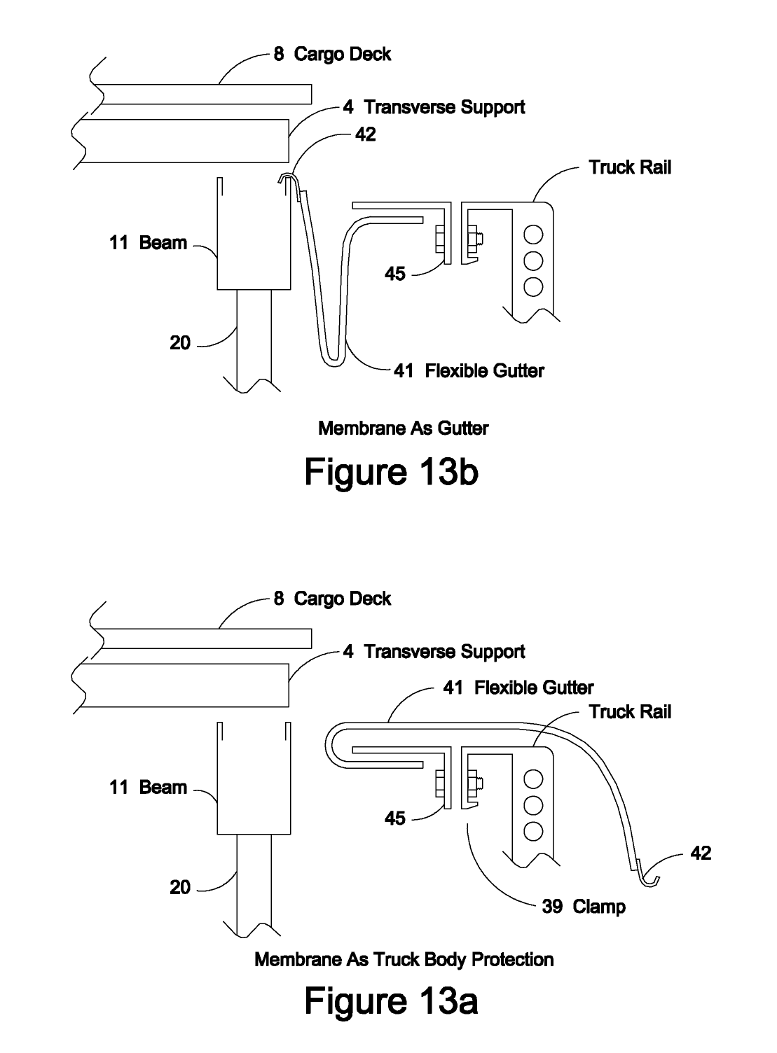

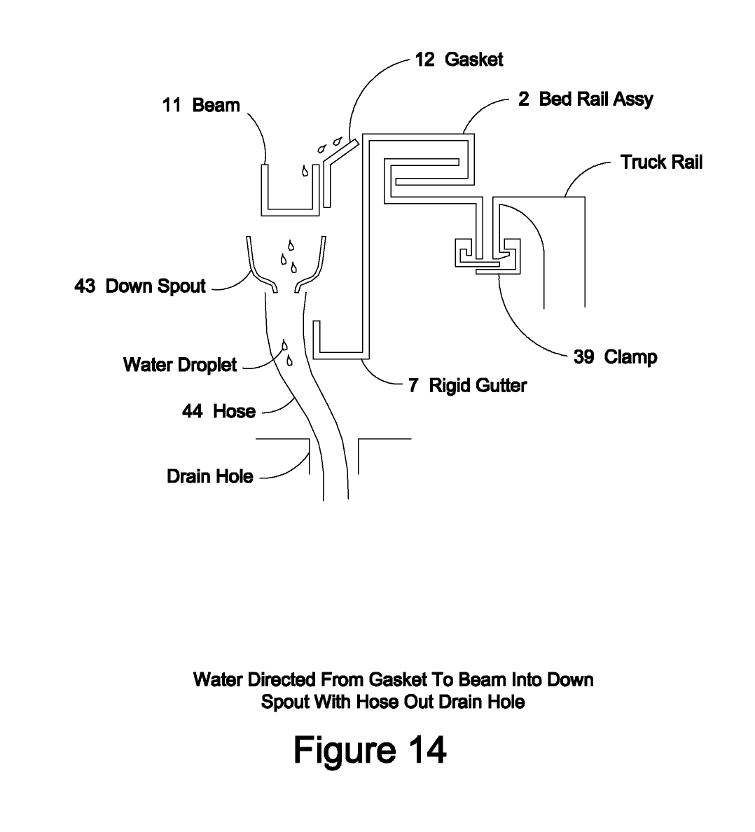

FIG. 13 shows another embodiment for a secondary channel. In this embodiment an elastomeric membrane 41 is used to capture any fluid that flows off the cargo deck. The longitudinal channels 11 will collect water from drain holes in transversal supports and direct it to the sump or tail gate hinge area. The elastomeric membrane 41 is attached to a mounting angle 45 by means threaded fastener or adhesive or similar method. The mounting angle 45 is then affixed to the bedrail of the truck by use of threaded fastener, clamp, welding, adhesive or similar method. To the free end of the elastomeric membrane 41 a plurality of hooks 42 are affixed by means of threaded fastener, adhesive or similar method. When in use, as shown in the top depiction of FIG. 13 the hooks 42 are placed over the outboard edge of the longitudinal channel 11 forming a channel that will direct any overflow from longitudinal channel to the sump 9 or tailgate are of the truck bed. As shown in FIG. 14 a downspout 43 and attached hose 44 can be used to direct collected fluid to an existing or fabricated drain hole 10 in the bed of the truck.

The jack supports 3 transfer the load supported by the longitudinal channels 11 to the bed of the truck. The jack supports can consist of jacking devices that could be of screw, scissors, ratchet, rack with pin, spring loaded, nested tube, or other type that are rigidly attached to a longitudinal channels 11 by welding, threaded fasteners or other means. A nested tube jack with a swivel joint 34 that connects the jack with the longitudinal channel 11 support beams is shown in the present embodiment, but could also be a spherical joint for greater freedom of motion. Jack supports 3 are capable of approximately 15″ of vertical adjustment using pins 18 so that cargo deck 8 can be raised to a level near that of bed rail and bed rail assembly 2, or lowered so that cargo deck is approximately 6″ or more below bedrail assembly 2. Jack supports 3 can be independently adjusted so that cargo deck 8 can be oriented in a horizontal position or inclined toward the front or rear of the truck, or to the right to left. FIG. 1 shows the forward inclined position. This position would aid in retaining cargo such as a boat or cargo with wheels such as dolly within the bed. A rearward inclined orientation could act as a ramp extension for loading an ATV for instance that would be secured to the bed rail assembly 2 with straps. An adjustable shim that extends between cargo deck frame and truck side wall will minimize deck from shifting from side to side, and when retracted would allow additional clearance between cargo deck assembly and inside edge of truck box side wall.

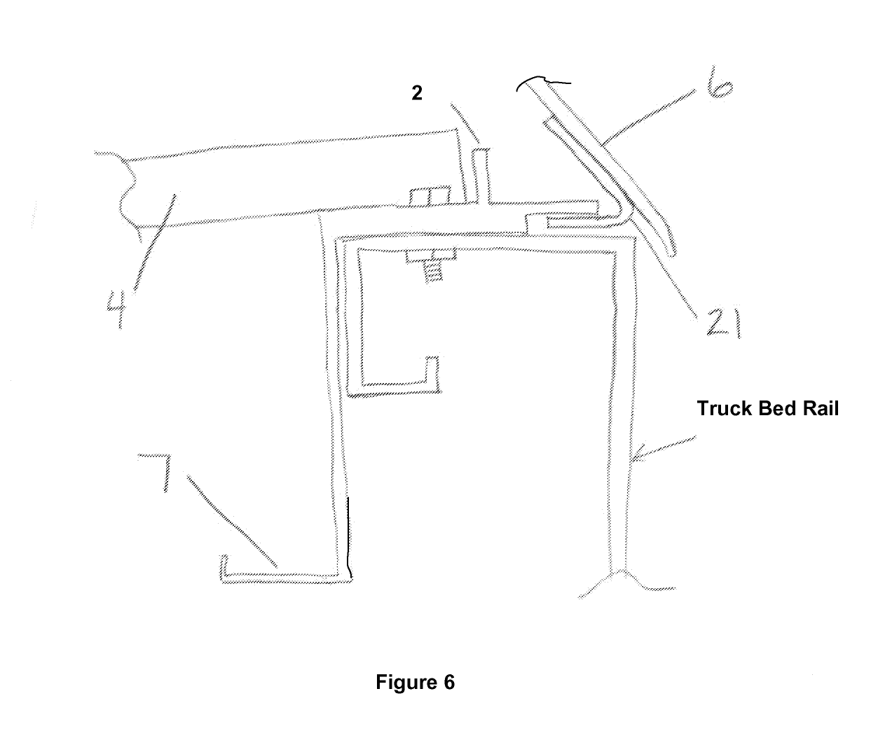

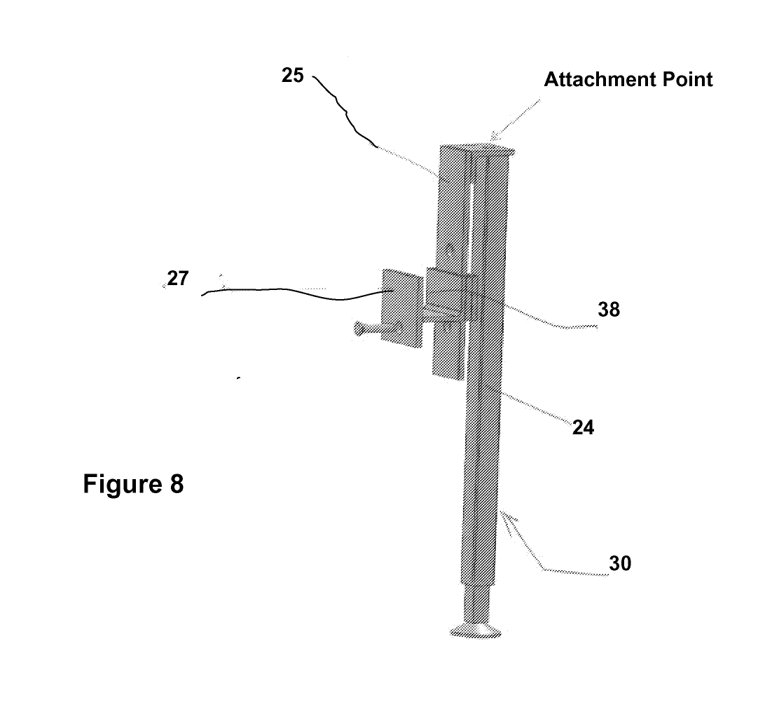

Another support embodiment is illustrated in FIG. 6 and FIG. 8. Hanger assemblies 30 shown in FIG. 8 are used to transfer load from longitudinal channel to the bed of the truck. The leg support is attached to or affixed to secondary channel 7 by using a threaded fastener or pin to pass through a hole in secondary channel 7 and into the hole used as an attachment point on the leg support 24. This prevents longitudinal and transverse motion. The leg support 24 could also be welded to the secondary channel 7 or bonded by other means.

The transverse support joists 4 are attached to longitudinal channels 11 by threaded fastener or other means and serve as the support surface for deck panels 13 and 14. A plurality of joists is located along and generally at right angles to the longitudinal axis of bed such that the concave surface of the transverse support joists 4, coincide with the interface of two adjacent deck panels 13 and 14. Additional joists can be installed if load on the cargo deck dictates. The concave surface of the transverse support joists 4 is oriented vertically up such that it captures any fluid that leaks between cargo deck panels 13 and 14. The joists then distribute this fluid to the longitudinal channels 11 for drainage to the sump 9 or to the tailgate area of the bed. Transverse support joists 4 also act as a tie down point for the deck panels 13 and 14 by means of a threaded T-Bolt 15 that mates with a threaded hole in joist in the present embodiment. These T-bolts, in conjunction with the latch hook 31 attached to the longitudinal channel 11 on a shaft to allow rotation, and the latch catch 33 attached to the deck panels 13 and 14 hold down the deck panels 13 and 14 while truck or trailer is in transit. To be able to raise the deck panels, the latch bar 32 that is connected to the latch hooks 31 by means of a shaft to allow rotation should be pushed forward rotating the latch hooks 31 away from the latch catches33 that are affixed to the deck panel by means of threaded fasteners, adhesive, or similar method. Instead of T-Bolts 15 another embodiment would consist of a T or L type bolt threaded into the bottom of the deck panels 13 and 14 and rotated so that the projection of the L or the T is on the underside of the transverse support joists 4.

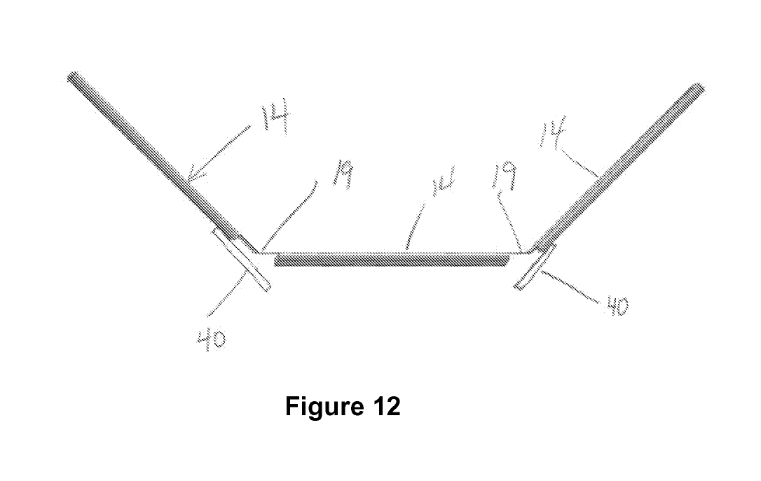

The cargo deck panels 13 and 14 rest on the transverse support joists 4, and consist of a plurality of panels, in the present embodiment three. The panels are of a suitable material wood, plastic, metal or composite that can be support the intended load that could include construction material of varying kind: furniture, lawn equipment or an ATV or boat. The panels are covered by EPDM or other elastomeric material using adhesive or similar method and are therefore waterproof. After the panels are covered with the elastomeric material they are joined together by an EPDM or elastomeric hinge 19. In the present embodiment three panels are connected by two hinges. The use of the elastomeric hinge 19 allows the panels to rotate relative to one another on an axis parallel to the longitudinal axis of the bed of the truck so that they may be opened similar to a typical door and that they can singularly, or in combination provide access to the interior of the truck or trailer while still being affixed to joists by T-bolts as shown in FIG. 4. If needed, they can also be removed completely by removing the T-Bolts 15 and then removing the deck panel 13 and 14. Then by removing the transverse support joists 4, complete access to the bed is provided. One other feature of the elastomeric hinges 19 is that based on the gap between adjacent panels, some rotation (twist) on an axis at right angles to the longitudinal axis of the truck or bed is allowed. This will compensate for small variations in height of adjacent transverse support joists 4. Any fluid deposited, by any means, on the surface of said panels must run to the gap between panels, or to the outboard edge of the panels. These leak paths are captured either in the longitudinal channels 11 or the transverse support joists 4 and from there are directed to the sump 9 or the tail gate area of the truck bed avoiding any cargo beneath the cargo deck 8. The deck panels 13 and 14 have a drip edge on the outboard edges to aid in directing fluid leakage to the longitudinal channel 11. On the other edges, the deck panels have expanded elastomeric backing rods underneath the EPDM or other elastomeric covering of the deck panels. These elastomeric backing rods 17 help form a compression seal between the mating deck panels 13 and 14 of cargo deck 8. FIG. 12 also shows that a rigid panel 40 can be affixed to the outboard deck panels 14 by means of threaded fastener, adhesive or other method. These panels 40 would prevent the deck panels 14, in a locked down configuration from being pulled up and providing access to the bed of the truck if the elastomeric hinges 19 fail or are cut.

The cargo deck 8 is comprised of plurality of deck panels 13 and 14, four in the present embodiment, and acts as a fluid barrier to the bed beneath, as well as a platform on which cargo can be loaded as shown in FIG. 1. FIG. 4 depicts four cargo panels installed. The cargo panels have dimensions such that an integral number will fully cover the bed. The interface between panels will fall within the concave area of a joists as can be seen in FIG. 1 and FIG. 4, and therefore any fluid that leaks between the panels is captured in the concave surface of the joists and then into the longitudinal channels 11 where it is drained to the sump 9, or the tailgate area.

FIG. 1 shows cut away view of EPDM cover 6 covering cargo 36 loaded on cargo deck 8. FIG. 6 is a detail view of the EPDM cover 6 and bed rail assembly 2 interface. Cover clips 21 formed from sheet metal or plastic, or molded from plastic are bonded to the EPDM cover 6 utilizing appropriate adhesive for both substrates. The clips are slid under the flange of the bedrail assembly 2. The free end is pulled over cargo deck 8 or cargo 36. The cover clips 21 on the free end are then slid under flange of the bedrail assembly 2 and are retained by the stress in the EPDM cover 6 due to its' elastic nature. In the present embodiment the EPDM cover 6 has a magnetic strip, attached by adhesive or other means to the forward end of the cover. The magnetic strip retains the front part of the cover to the ferrous bed of the truck or trailer. In other embodiments the cover 6 may be bonded to the front end of the bed using adhesive. To retain cover at the rear of the bed, a dowel 22 of a substantially rigid material is installed in a pocket in the

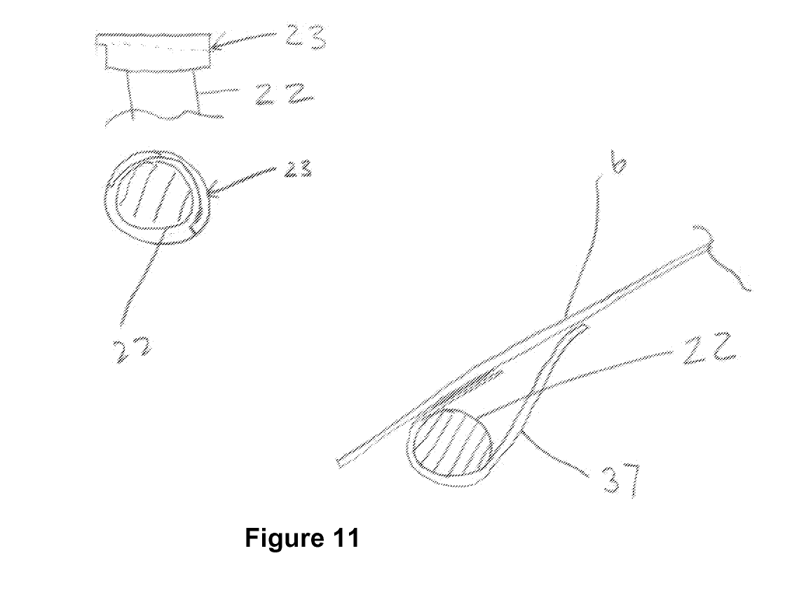

EPDM cover. FIG. 11 illustrates the dowel 22 inserted in the EPDM cover pocket 37. A pocket is formed by bonding a loop to the EPDM cover 6 resulting in a pocket the dowel 22 can be inserted into. The dowel 22 is then inserted in the retainers 23 located near the tailgate of the bed. The retainers 23 can be seen in FIG. 11 and FIG. 7. The elastic property of EPDM or other elastomeric materials create a stress in the material when it is stretched beyond its' unloaded dimensions that will aid in the dowel 22 being retained in the retainers 23. The ability of the EPDM cover to stretch, allows oversize cargo to be covered. In a trailer application the attachment method could take the form of clips or dowels on all four sides for instance, due to user access to trailer on all four sides as opposed to the bed of a pick up truck with access on three sides due to cab. Or if sufficiently protected from wind by the tow vehicle, and of sufficiently small wind impingement area, magnetic strips could be used on all four sides.

FIG. 7 shows a configurable cargo system according to one embodiment. This embodiment consists of the same components as embodiment illustrated in FIG. 1 with the exception that load hangers 25, sliders 27, and leg supports 24 are used to support longitudinal channels 11 rather than jack supports 3. FIG. 8 shows these assembled parts removed the truck bed. The load hangers 25 are rigidly attached to leg supports 24 by welding, threaded fastener or similar method. These parts are rigidly attached to the secondary channel 7 by drilling or boring a hole in the secondary channel and using a threaded fastener such as a bolt passed through the secondary channel into the attachment point in the load hanger 25 leg support 24 assembly. The secondary channel 7 is rigidly attached to the bedrail by threaded fasteners, clamps, welding or other method, and therefore. The sliders 27 have a hollow channel through which the load hangers 25 are inserted, and then sliders 27 can be vertically adjusted and pinned at desired height. This embodiment provides approximately 12″ of vertical adjustment. Independent adjustment of sliders allows cargo deck to be oriented in a horizontal or inclined position as with embodiment in FIG. 1. After the sliders 27 are adjusted and pinned, the longitudinal channels 11 are placed in the U shaped bracket 38 of the slider 27. The longitudinal channel 11 is then fixed in the position using a c type clamp or threaded fastener for instance.

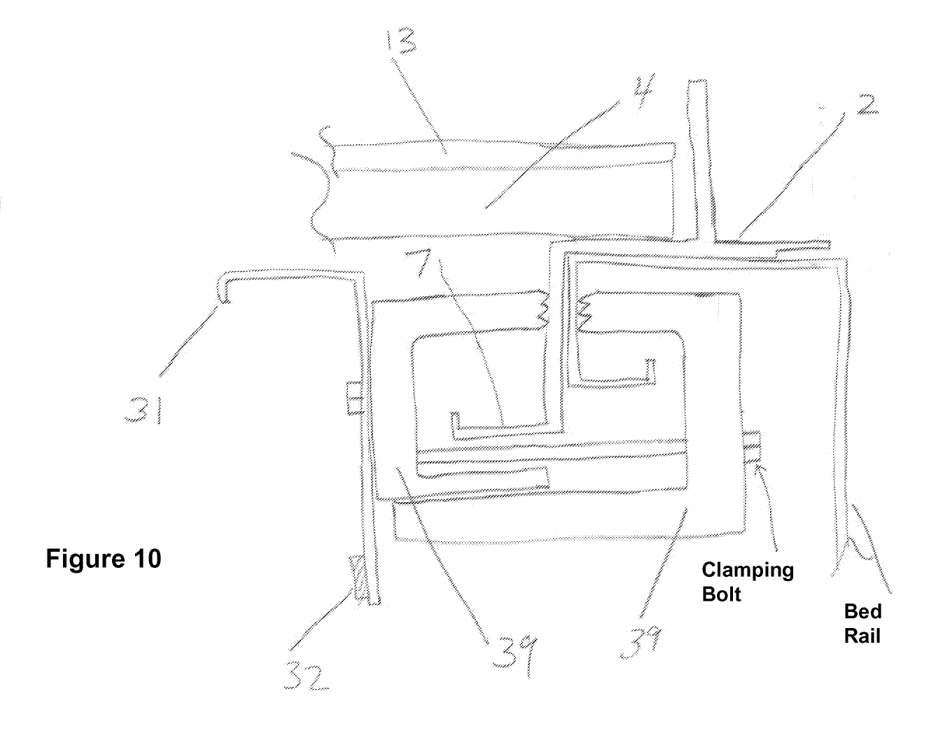

A further embodiment could also include a cargo deck 8 at a fixed height. This embodiment would not use any jack supports 3 or load hanger assemblies 30. The longitudinal channels 11 would also be removed. As shown in FIG. 10 the transverse support joists will rest on and be supported by the bedrail assembly 2. The bedrail assembly would run essentially the length of the bedrail. The deck panels 13 and 14 rest on the transverse support joists 4 as In previous embodiments and are held in place by the T bolts 15 threaded into the transverse support joists 4. FIG. 10 is a cross section of one possible embodiment. The bedrail assembly 2 fabricated by extruding or welding or similar method, is clamped to bedrail of truck by C shaped clamp 39 utilizing clamping bolt. Other methods of rigid attachment to the bedrail of truck could include: threaded fastener, clamps, anchors installed in the stake pocket of the bedrail, or even adhesives or welding. The lower horizontal leg of the acts as a secondary channel 7 to capture fluid leakage and direct it to the sump 9 or to the tailgate area. The deck panels 13 and 14 and cargo deck 8 function as before with the exception of raising or lowering. The interface with the EPDM cover 6 would also be the same as in previous embodiments.

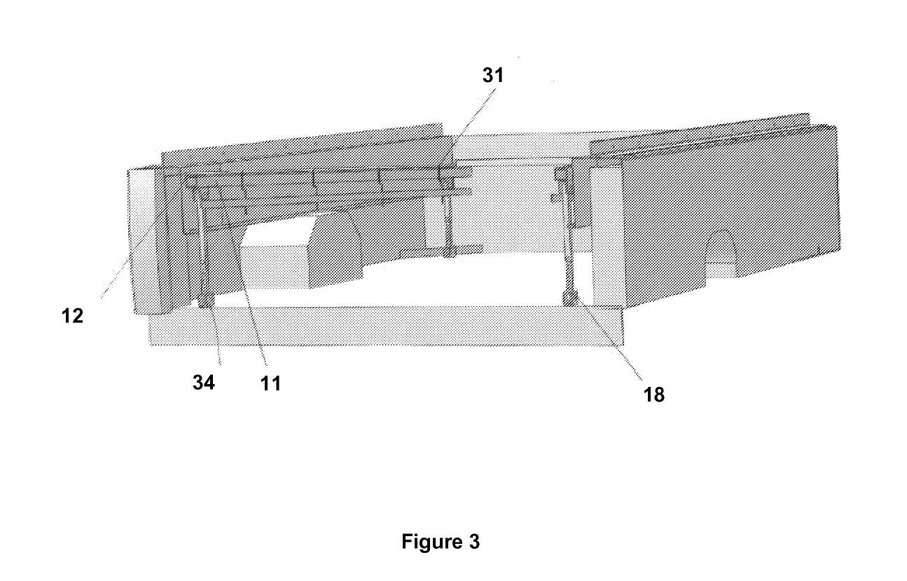

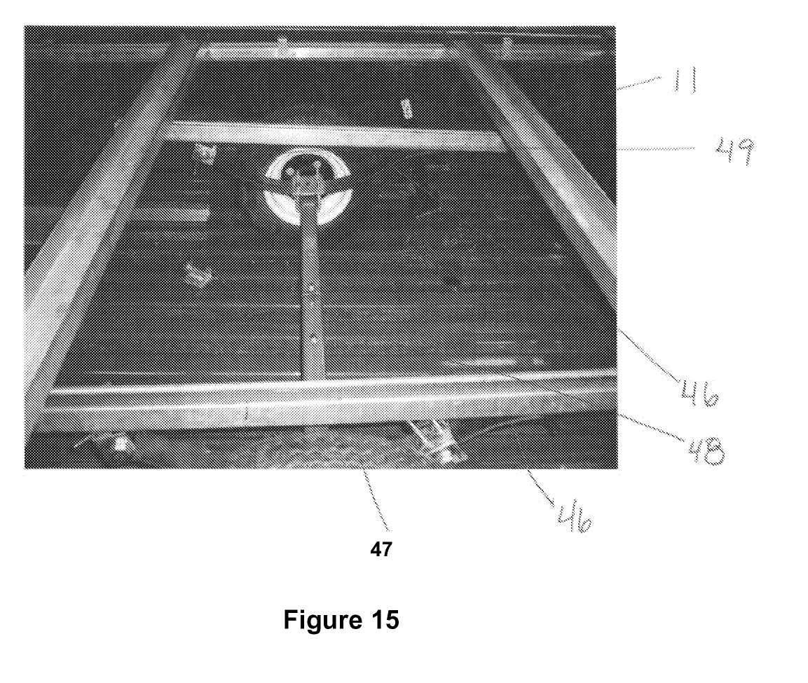

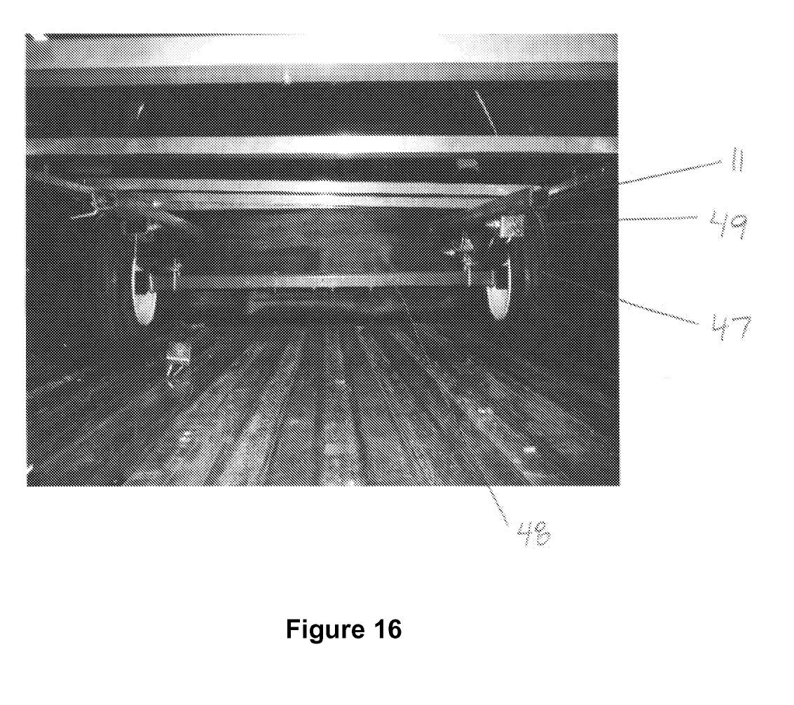

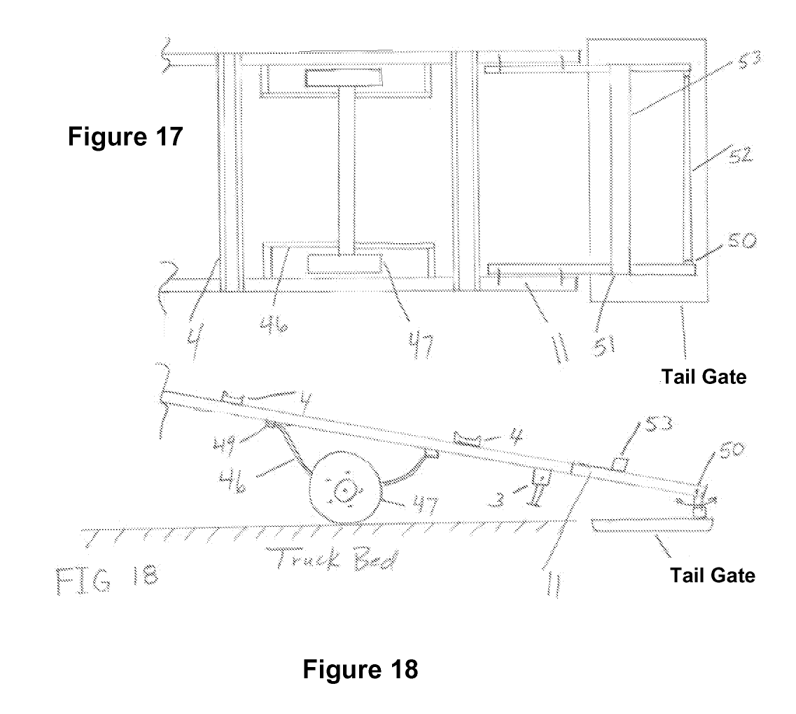

FIGS. 15 and 16 depicts another embodiment. This embodiment is the same embodiment depicted in FIG. 3 except that a suspension system with axles and wheels has been attached to the longitudinal channels 11. Longitudinal jack supports 3 are not shown for clarity. Leaf springs 46 are attached to longitudinal support channels 11 by brackets 49 that are affixed to the longitudinal channels 11 by welding, threaded fastener or similar method. The leaf springs 46 are further attached to an axle with wheels with U-Bolts as in a standard trailer axle. In use, the axles and wheels provide a pit point to rotate longitudinal channels 11 to desired degree of inclination and then set support jacks to hold the longitudinal channels in this position. The transverse support joists 4 and deck panels 13 can then be added forming and inclined cargo deck. The EPDM cover 6 can then be used as discussed previously.

The embodiment depicted in FIG. 15 and FIG. 16 also allows parts of the configurable cargo system to be removed from bed of truck and be used as a small trailer, for towing behind an ATV for instance. The longitudinal jack supports 3 can be removed, or if attached by rotatable joint, can be rotated out of the way. The longitudinal jack supports 3 support the load, and to provide transverse (sway) mechanically actuated shims placed between the bed rail and the longitudinal channels 11 will be used. Once the longitudinal jack supports 3 are removed, or rotated out of the way, the tires are then taking the load. The longitudinal channels 3 with transverse support joists 4 and deck panels 13 can then be rolled or winched out of the bed and onto the ground with the use of ramps for instance. Once there, a tongue can be rigidly attached to the longitudinal channels 11 or the transverse support joists 4. At the end of the tongue a standard ball type or pin type or other hitch can be attached for towing.

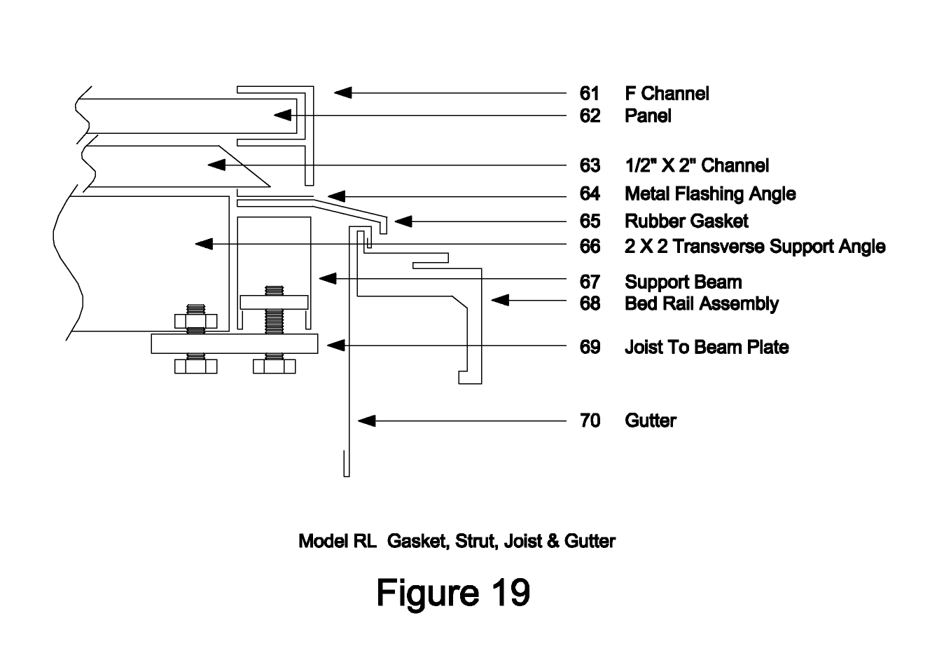

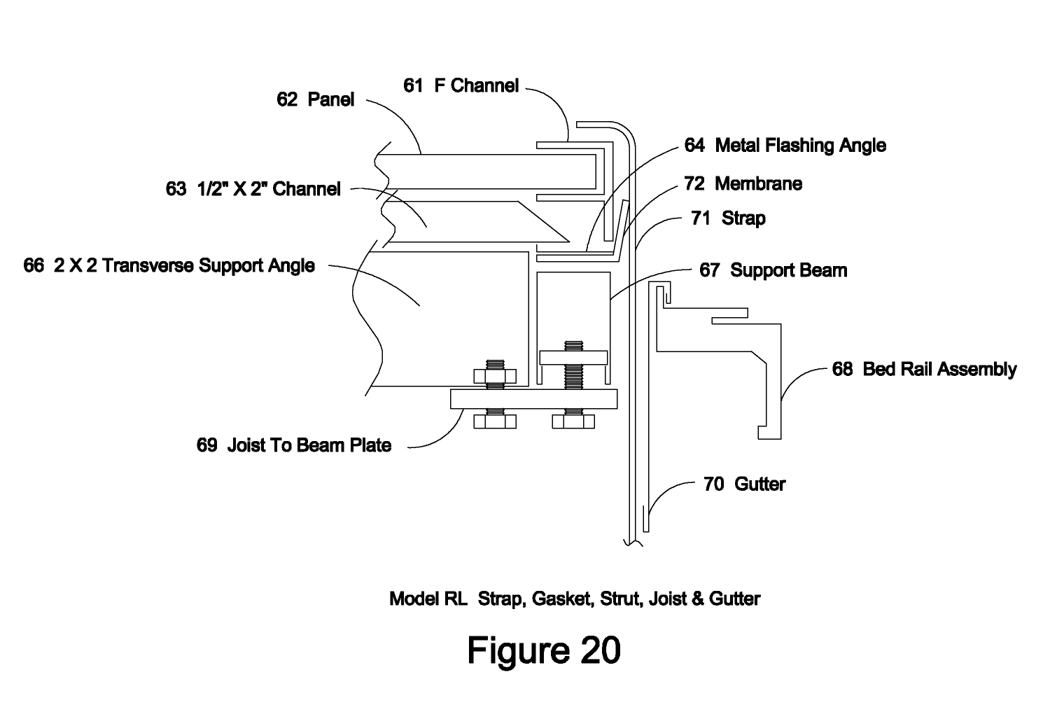

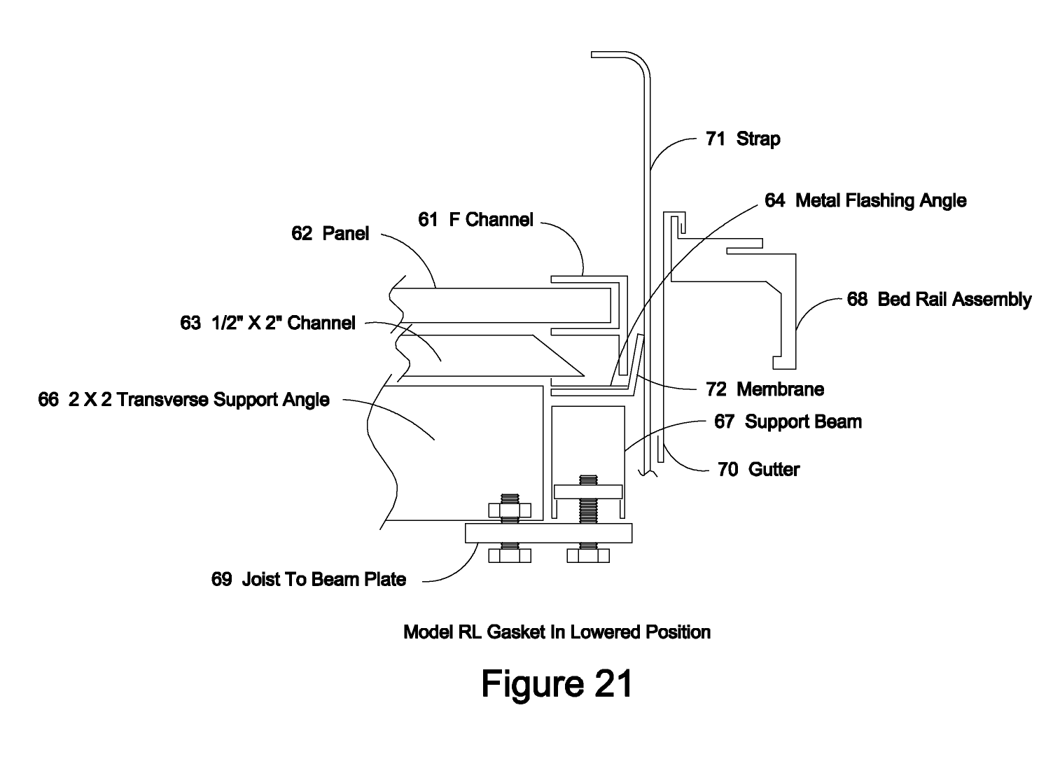

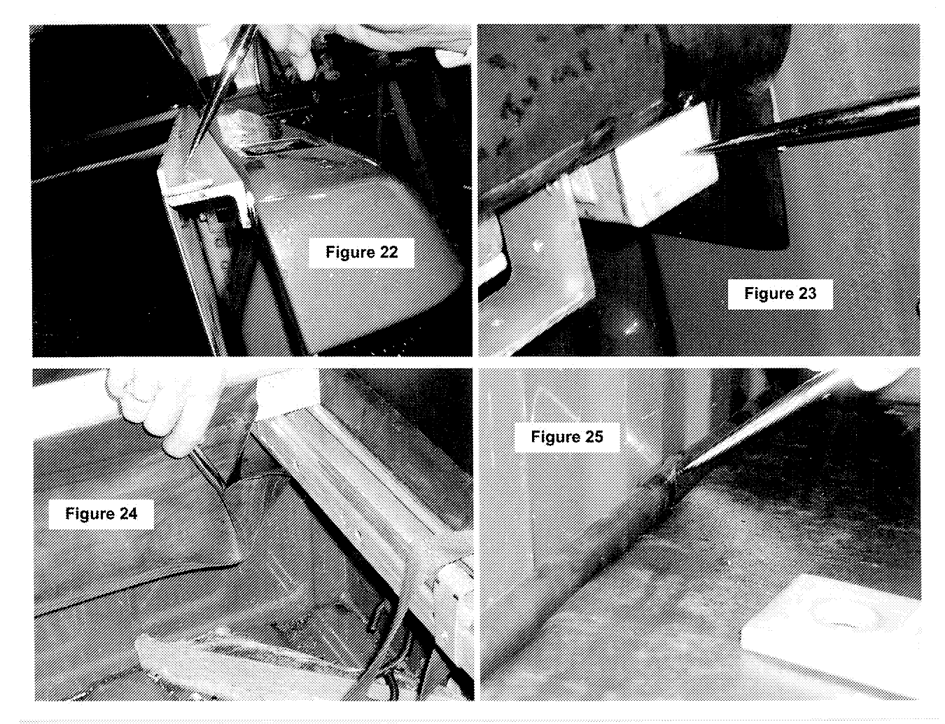

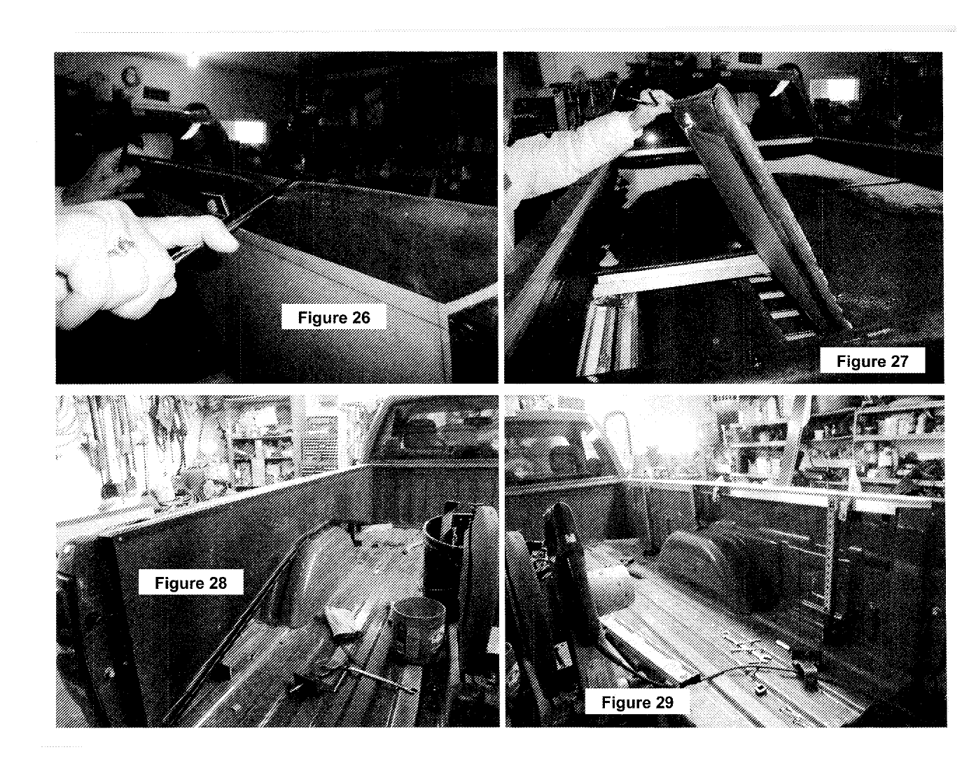

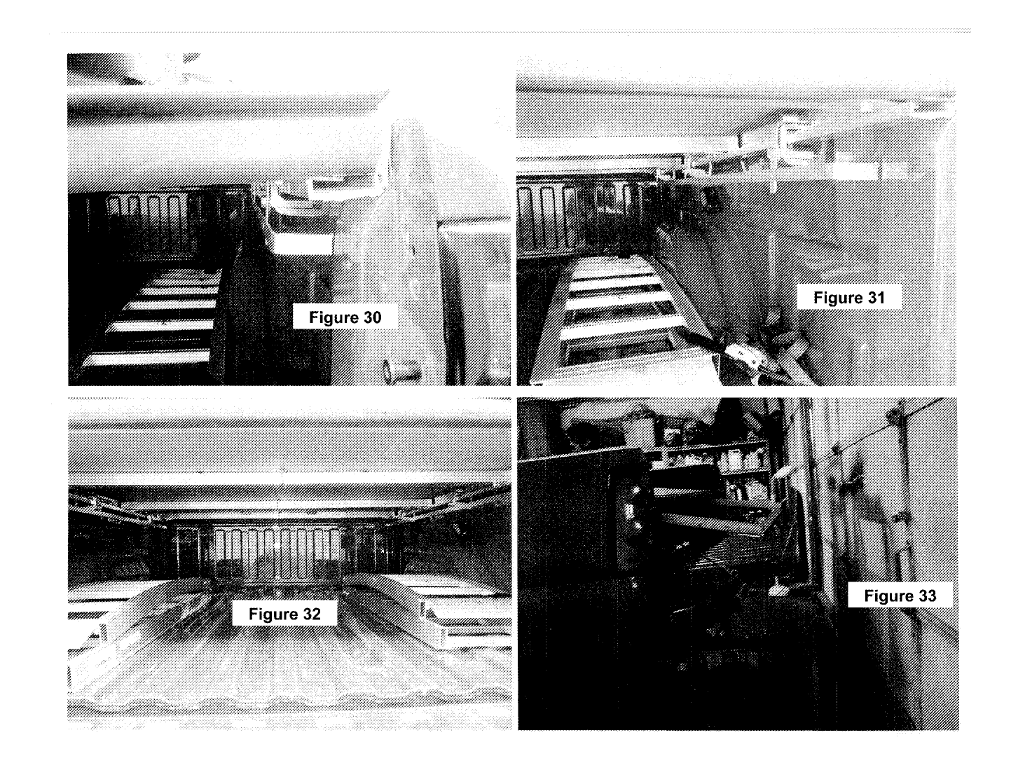

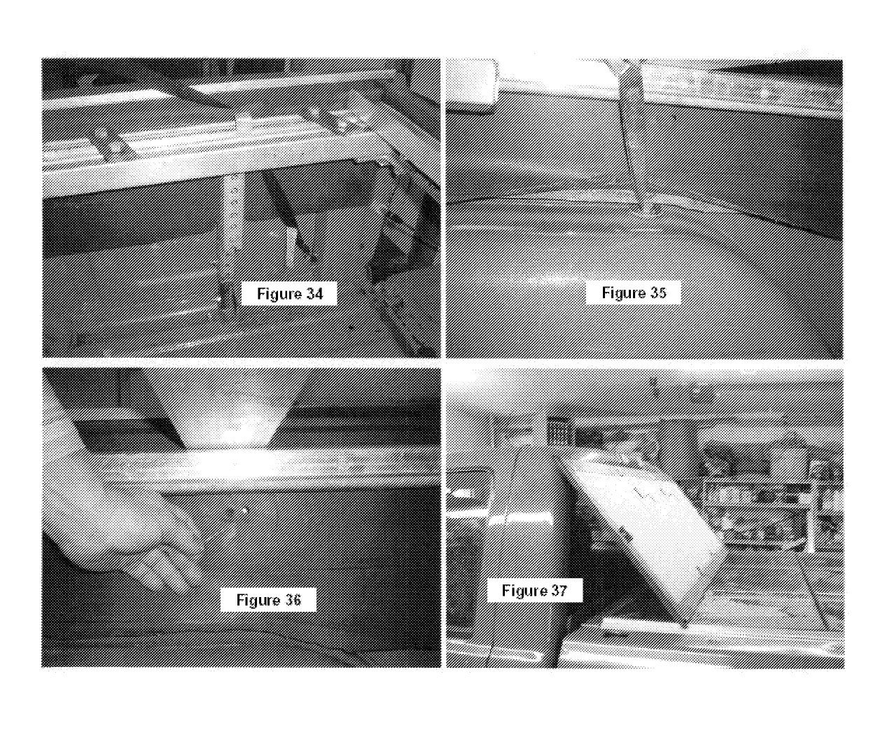

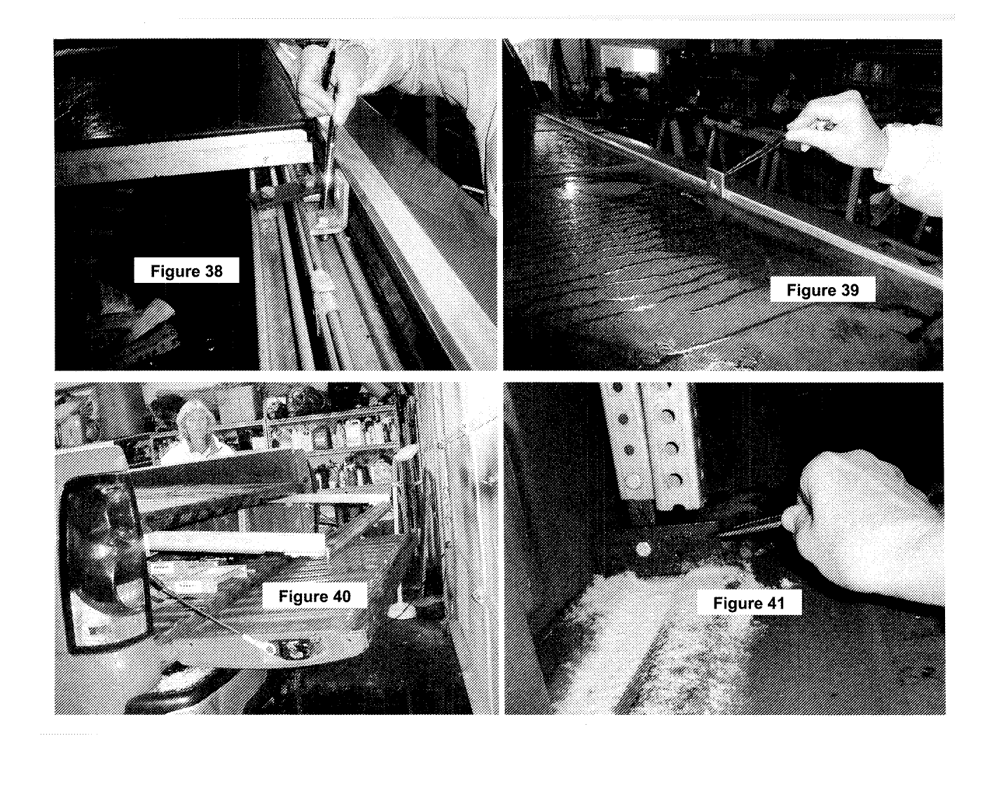

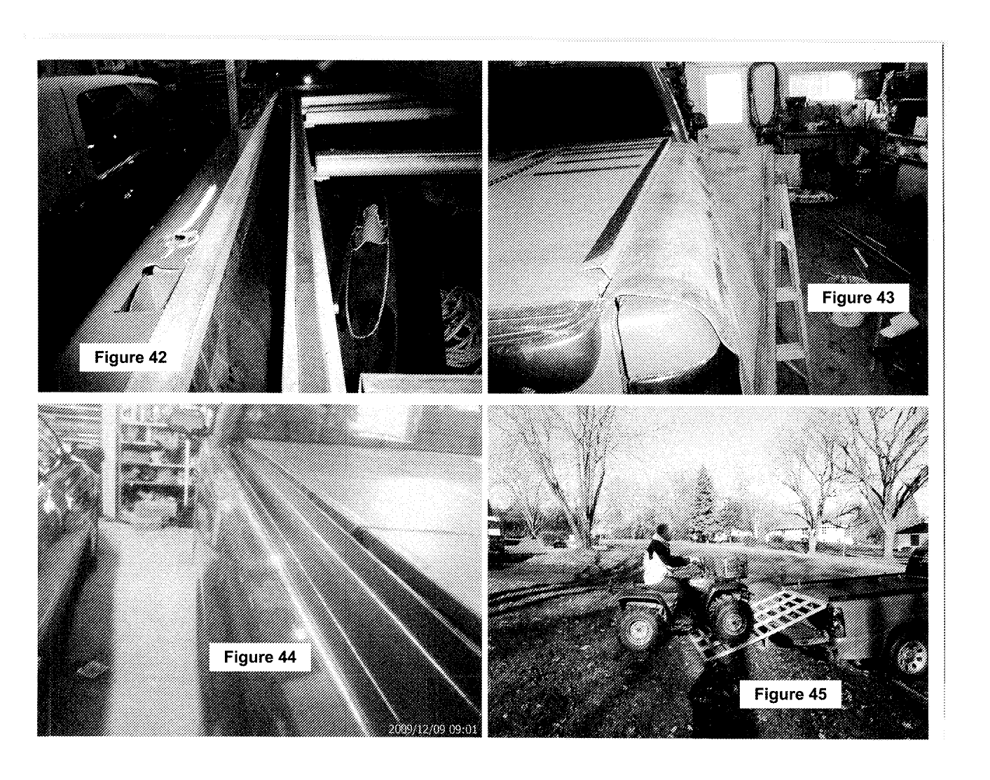

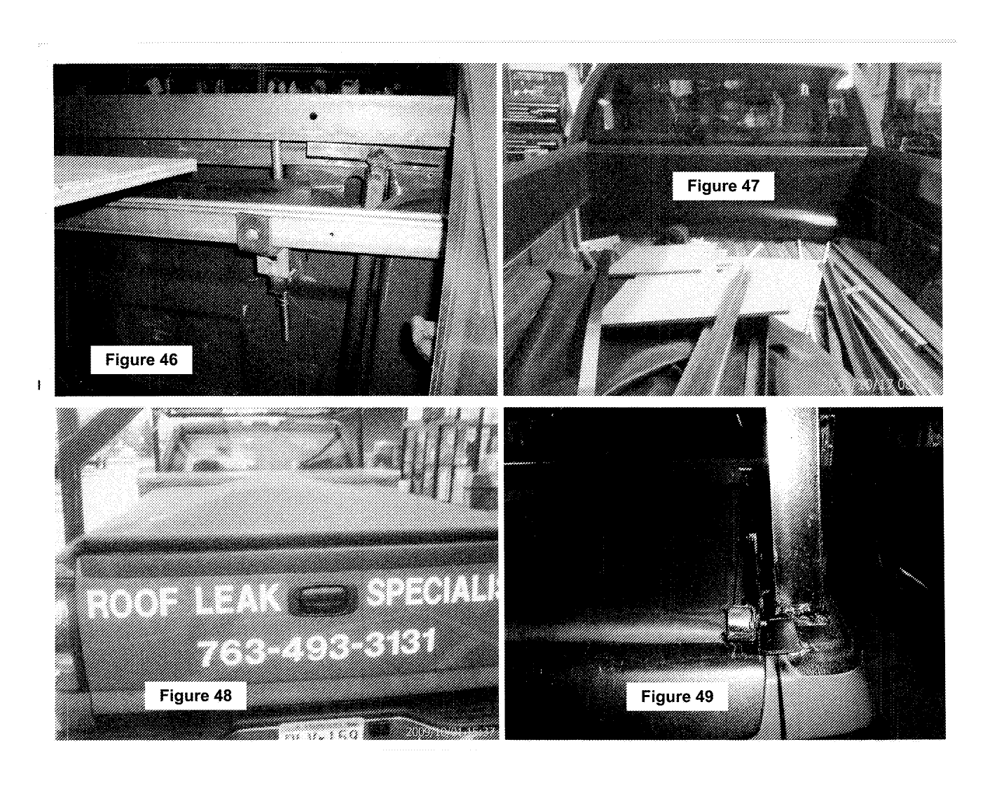

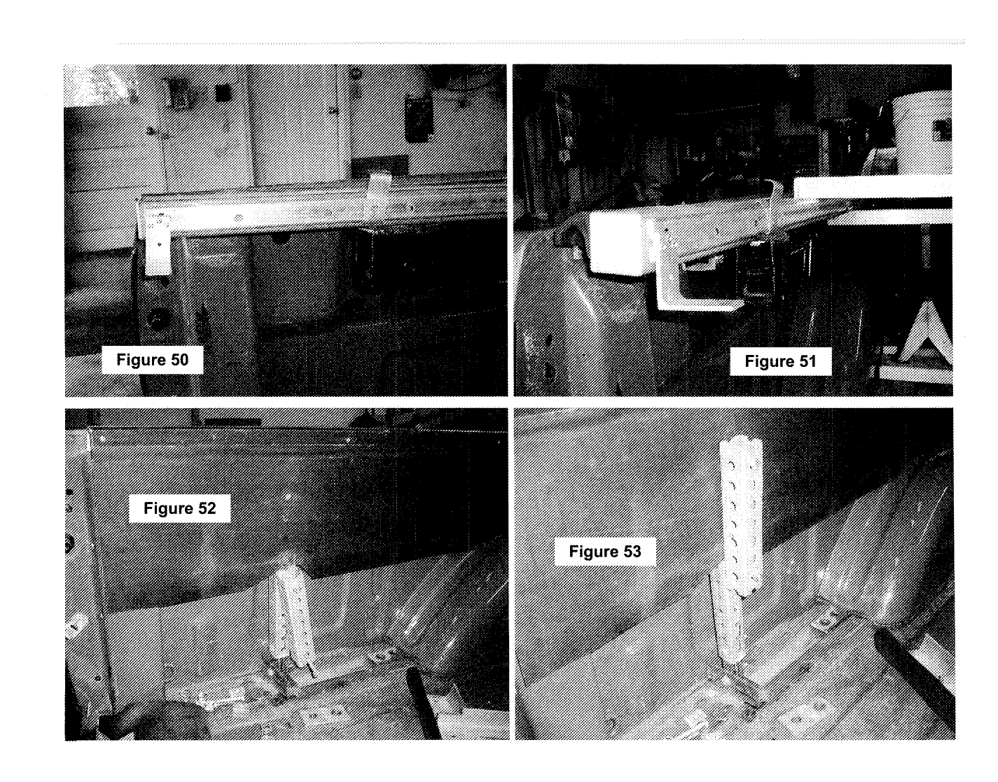

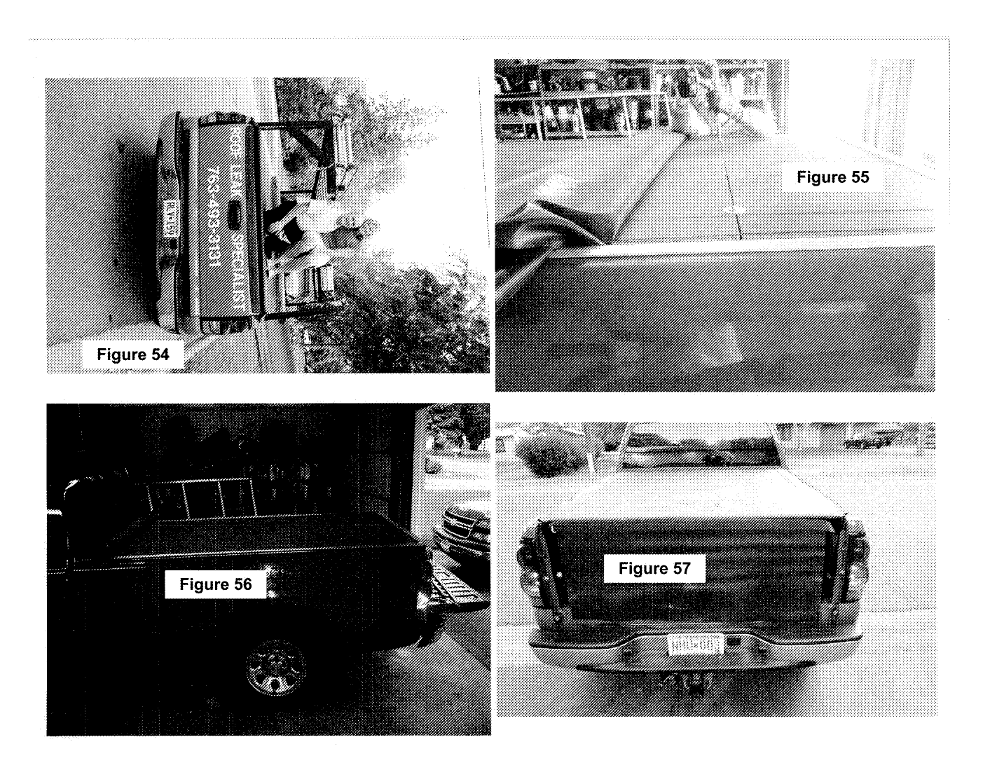

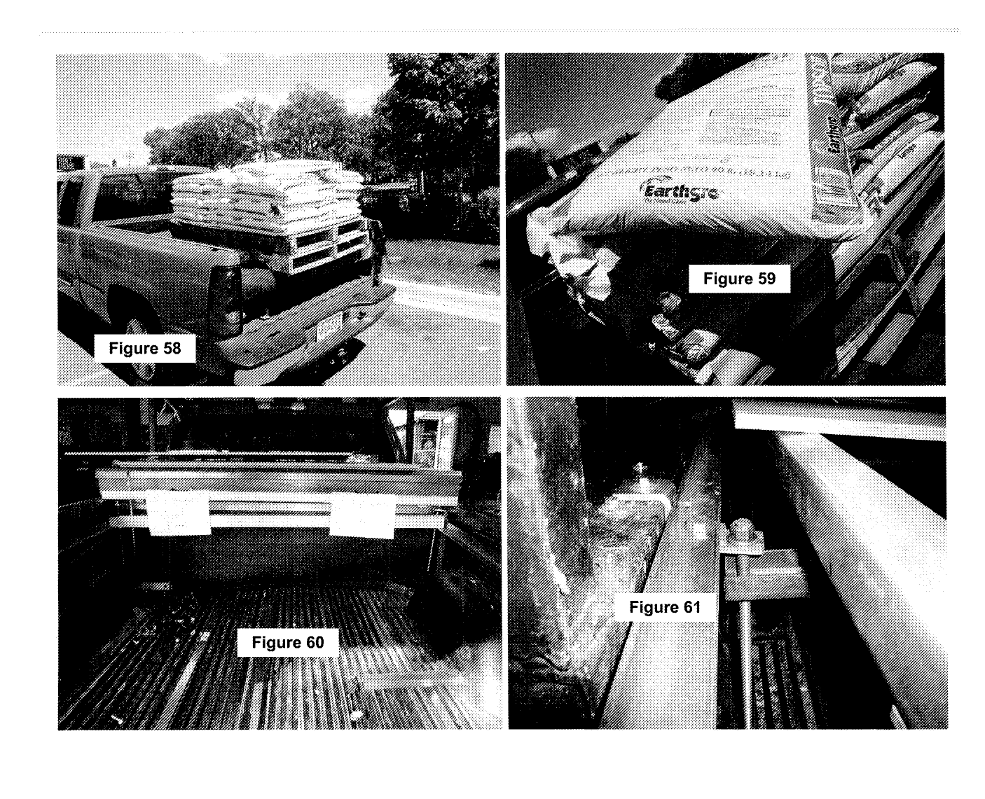

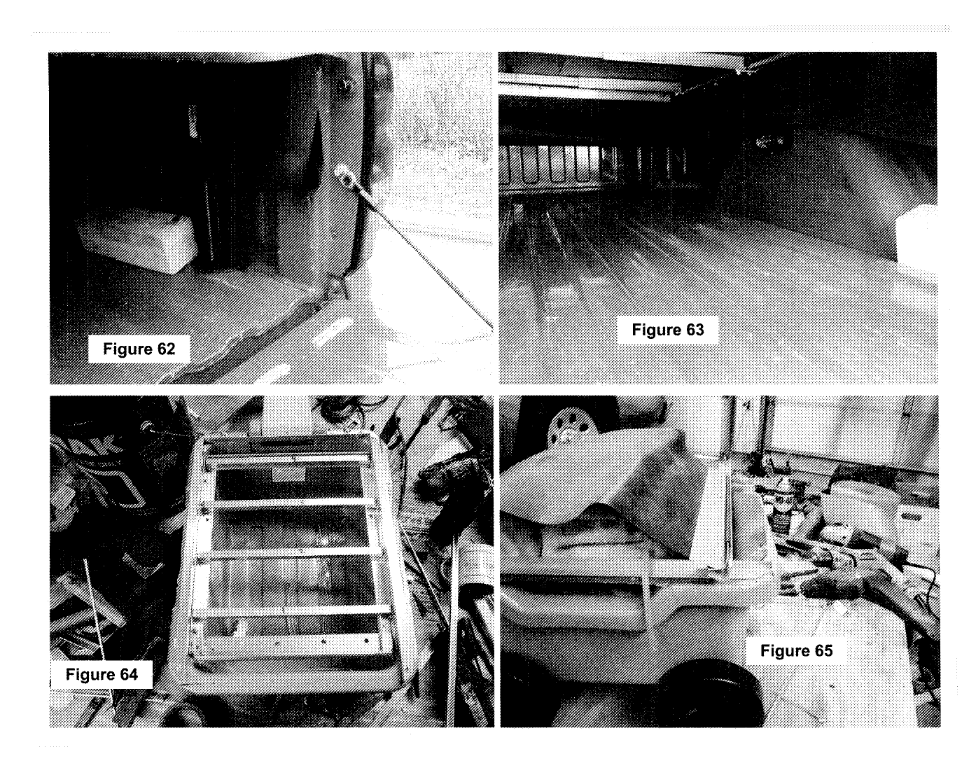

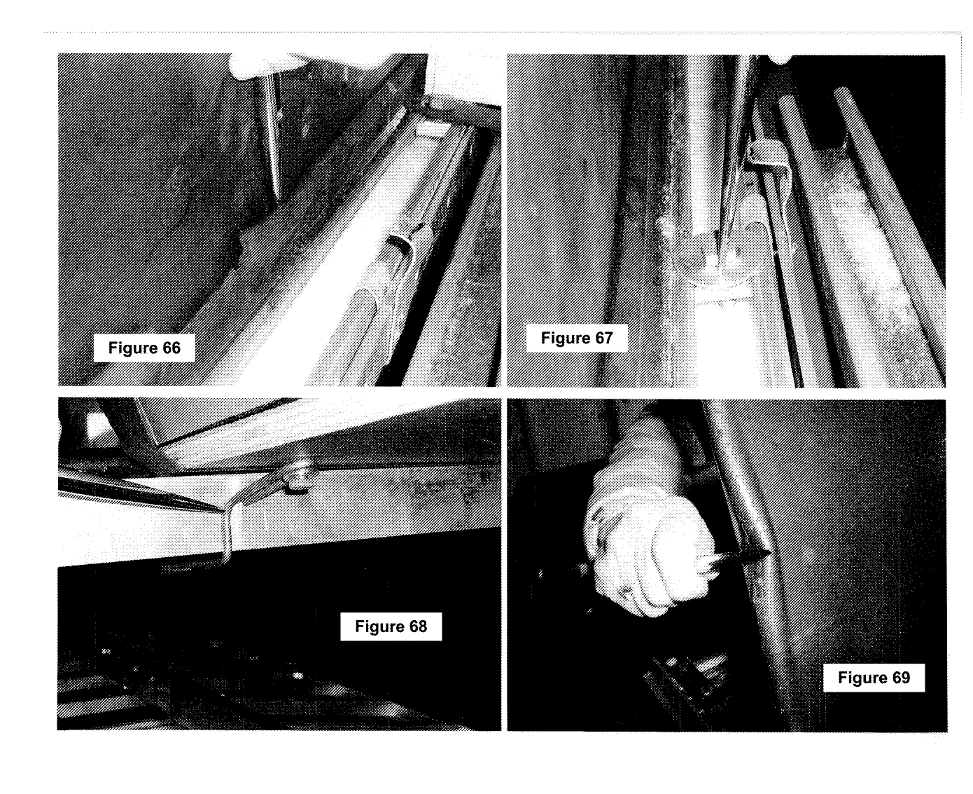

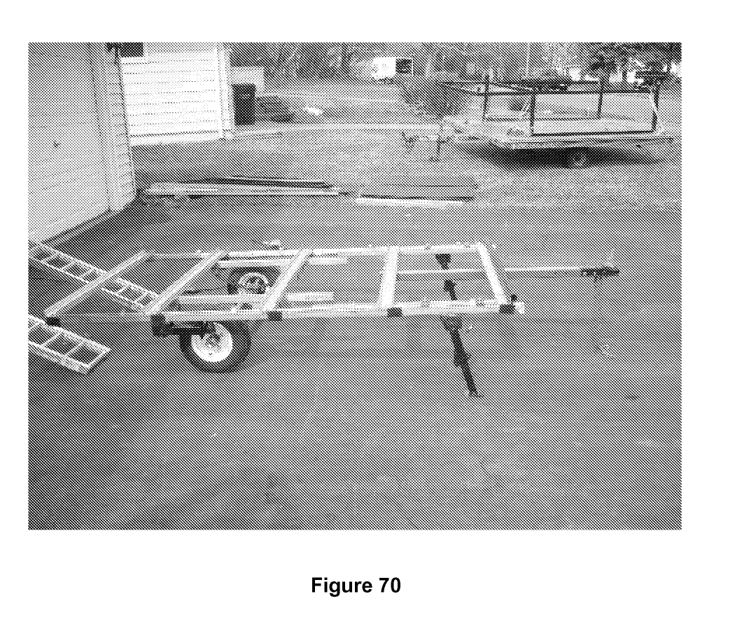

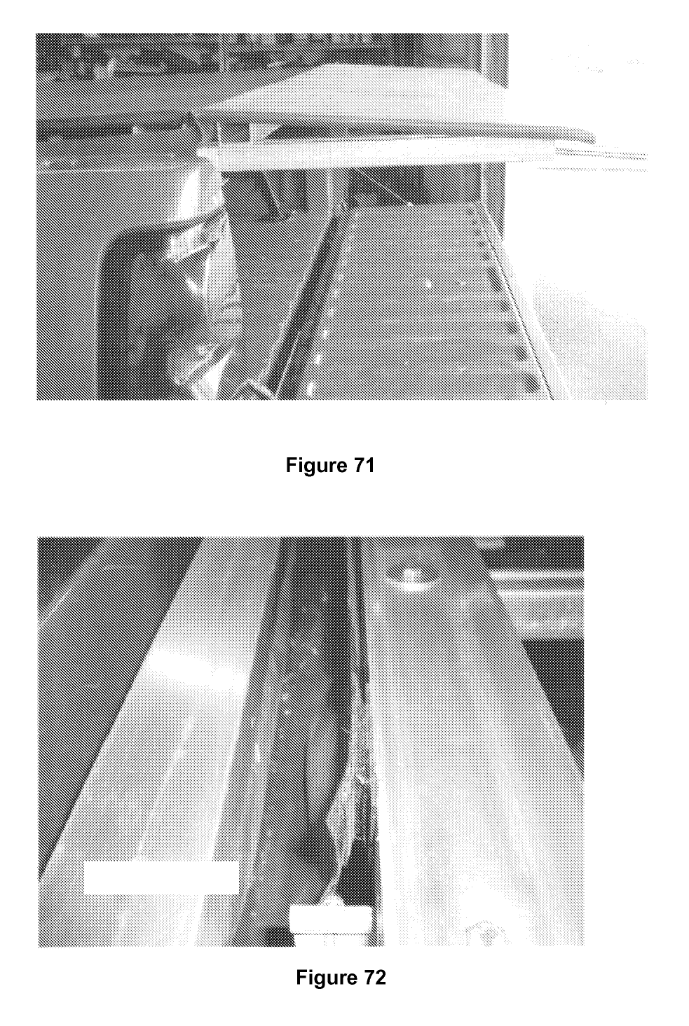

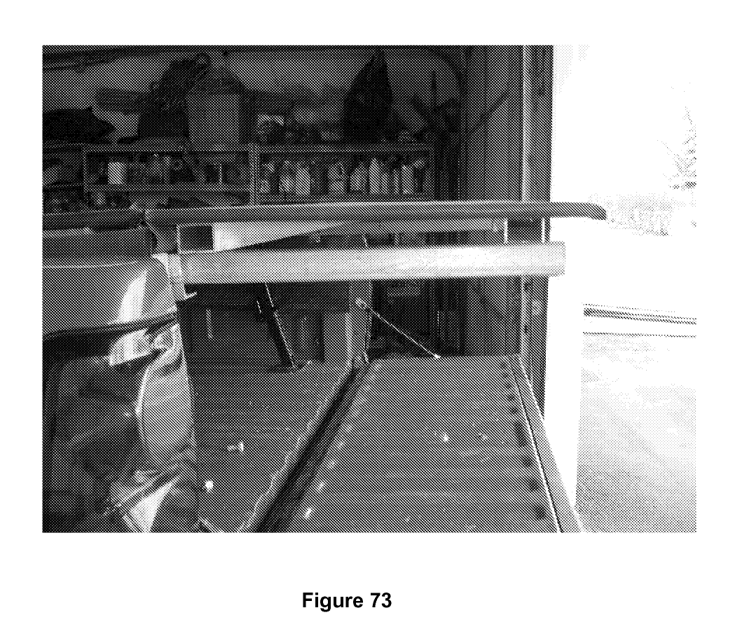

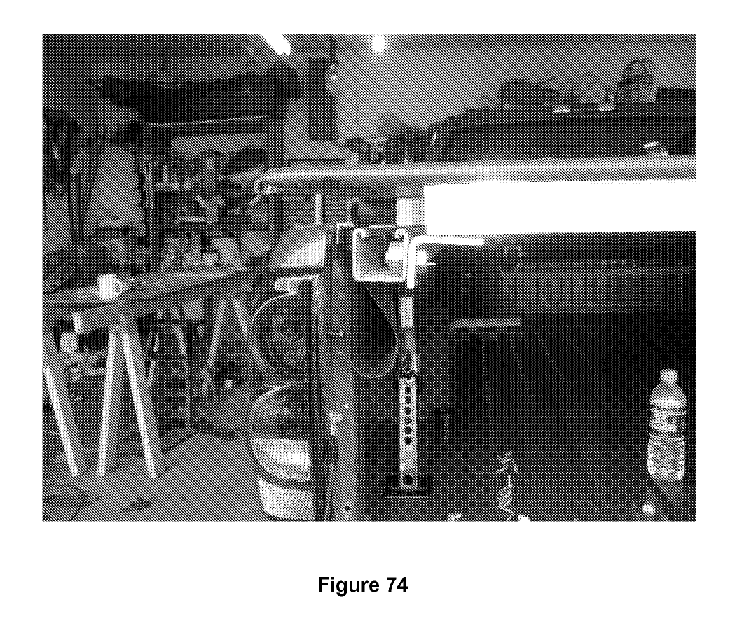

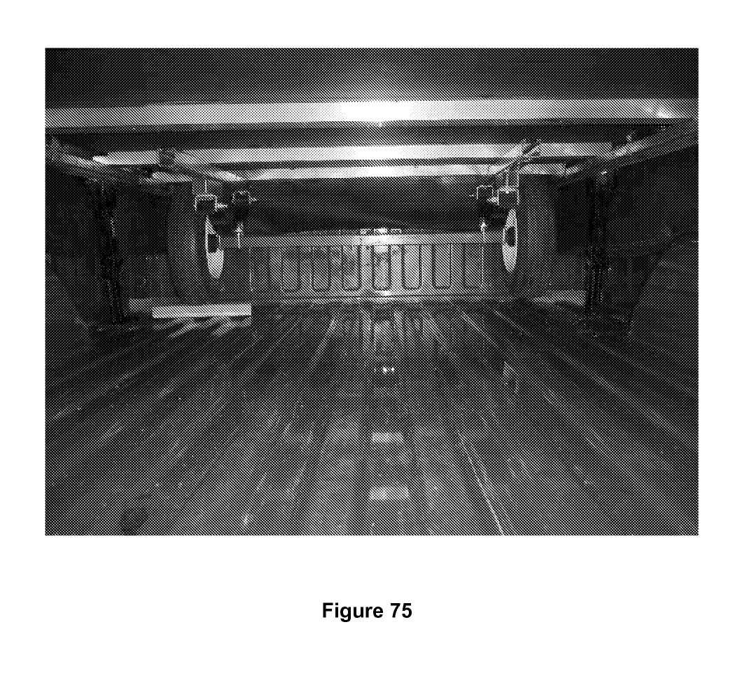

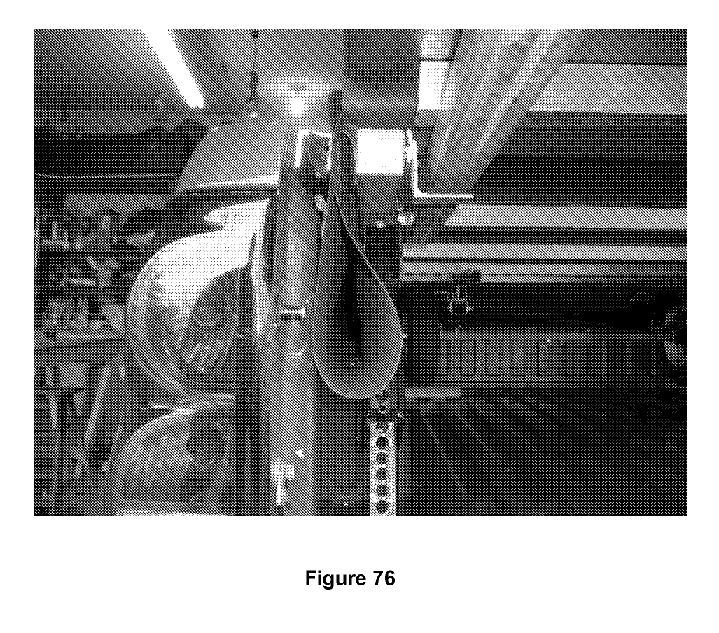

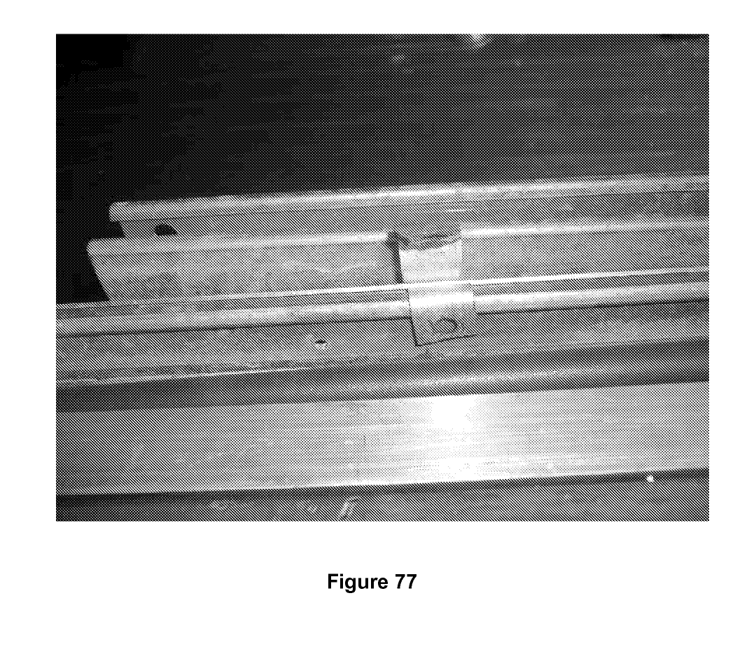

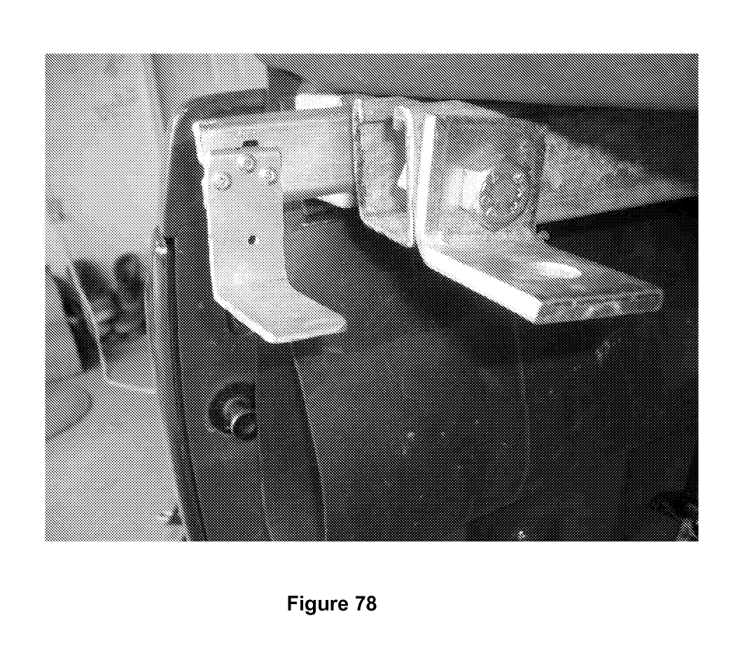

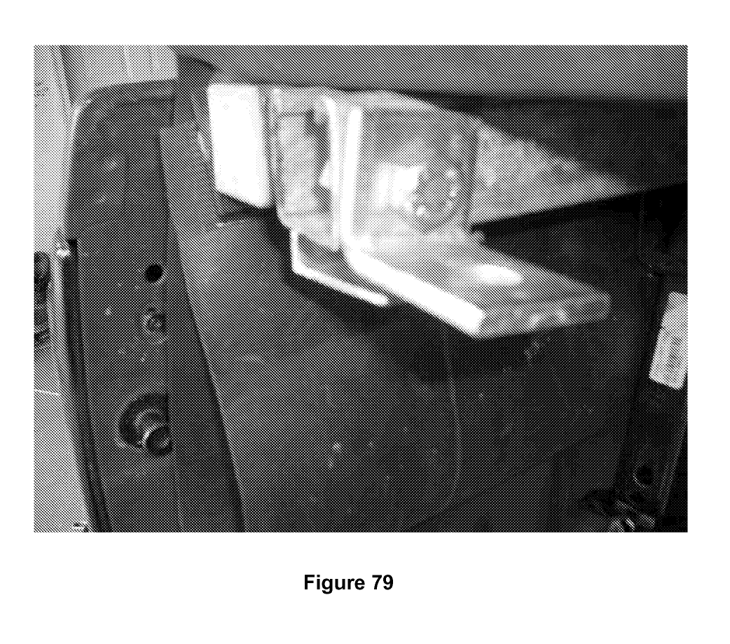

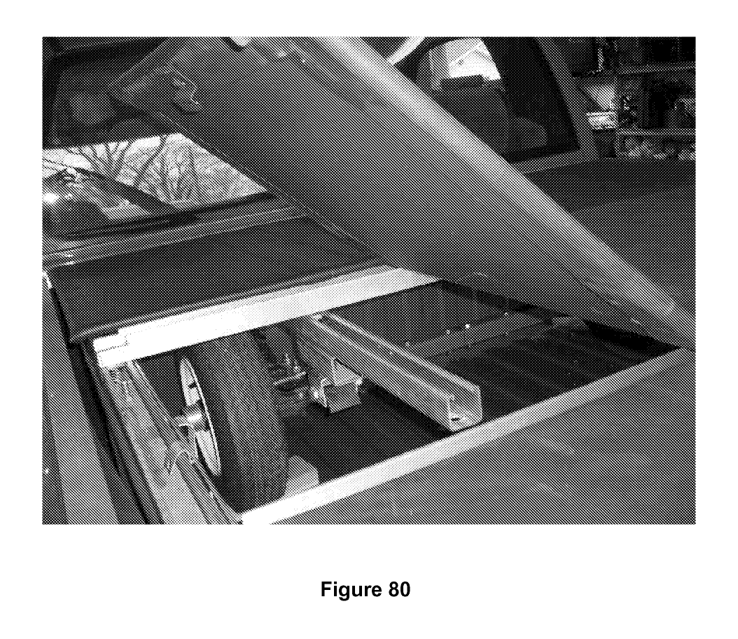

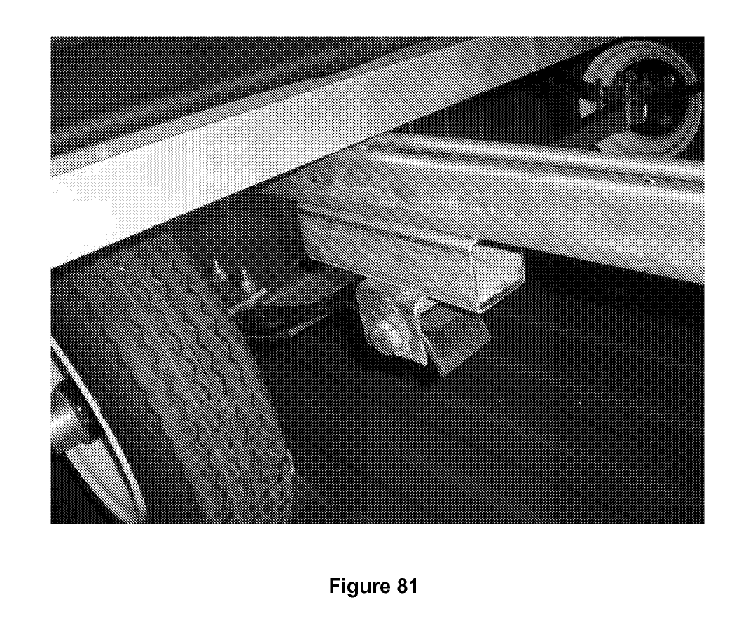

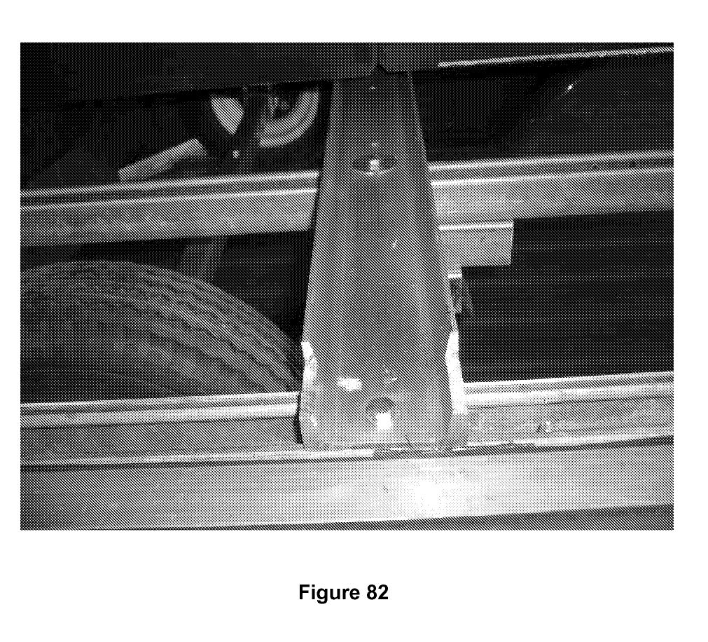

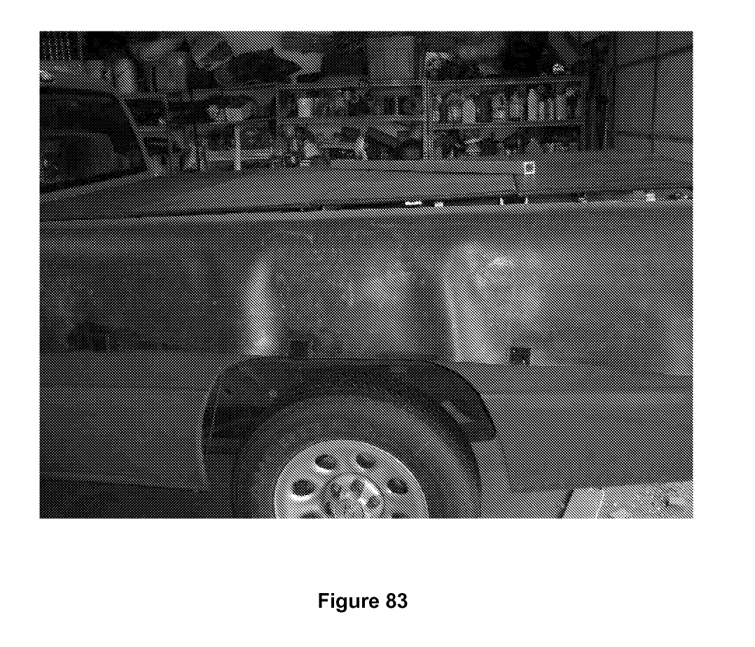

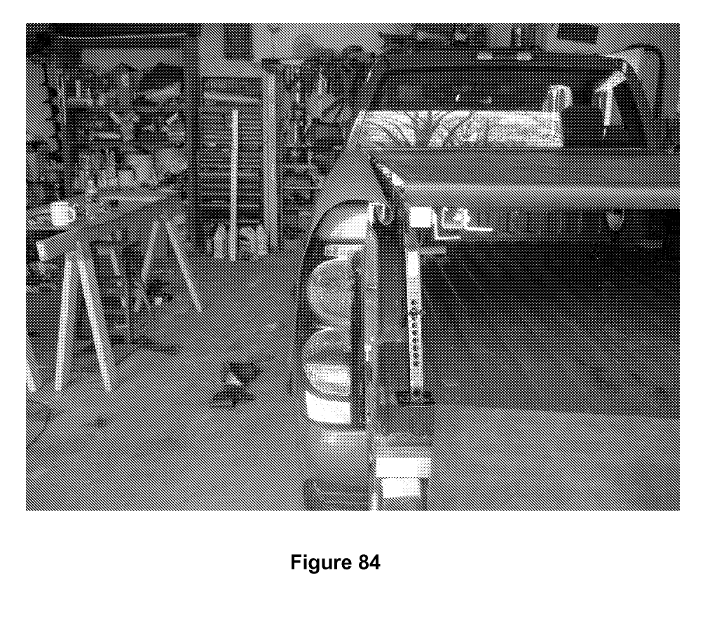

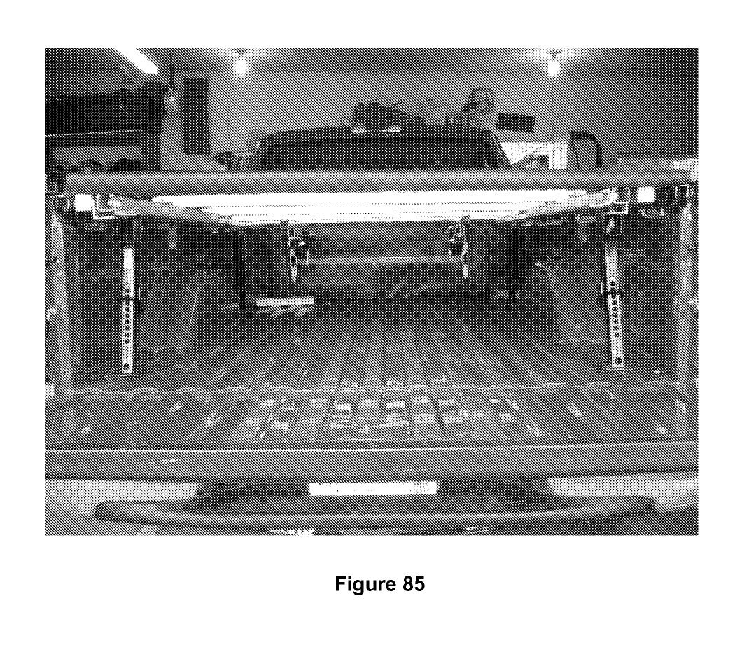

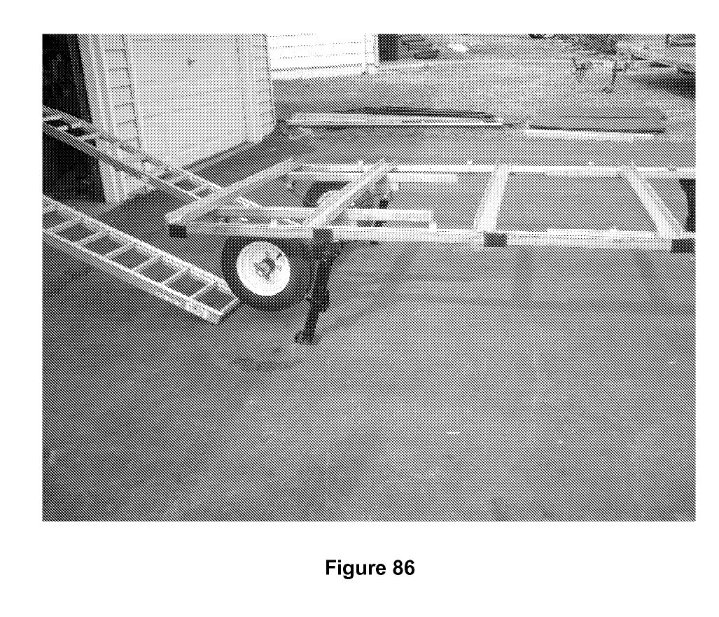

FIG. 18 shows extendable longitudinal channels 51 that can be used as a ramp over the tail gate as one use. An inclined position for the longitudinal channels is shown. These extendable longitudinal channels 51 are connected to the longitudinal channels 11 by threaded fasteners for instance with both the extendable longitudinal channels 51 and the longitudinal channels 11 having slots for the fasteners that would allow sliding motion relative to one another. When cross bars 53 are placed across these extendable channels 51 and affixed with clamps for instance, planking (not shown) of wood, metal, or other rigid material appropriate for load can be can be used to form a ramp. The extender cross bar 52 is rotatable attached to the extender longitudinal channels 51 be means of a rotatable joint 50, a shoulder bolt for instance. The extender cross bar 52 can then be used as a foot for the extendable longitudinal channels 51 as shown in FIG. 18, or can be rotated to be used as a cross bar similar to cross bar 53 to support planking.

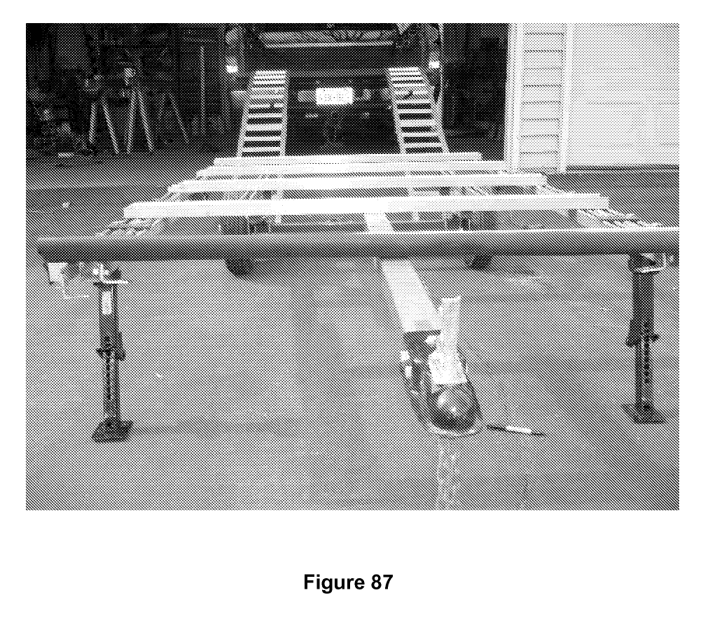

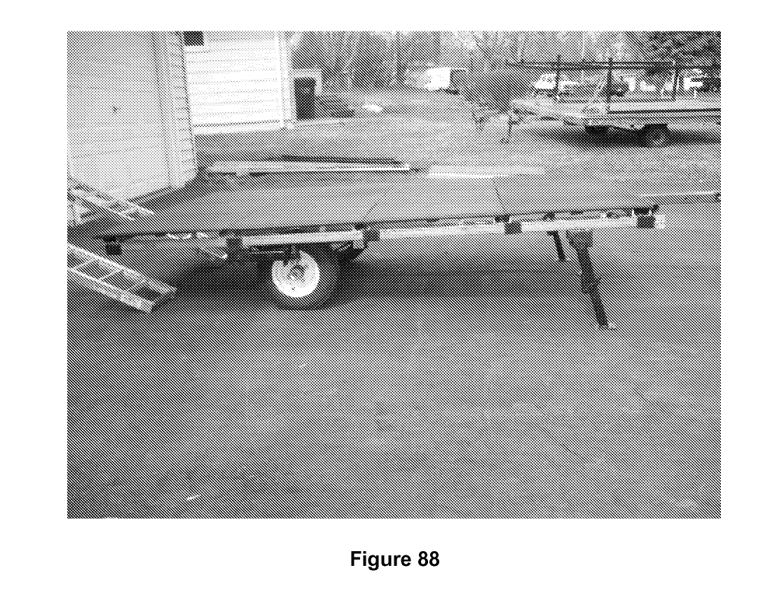

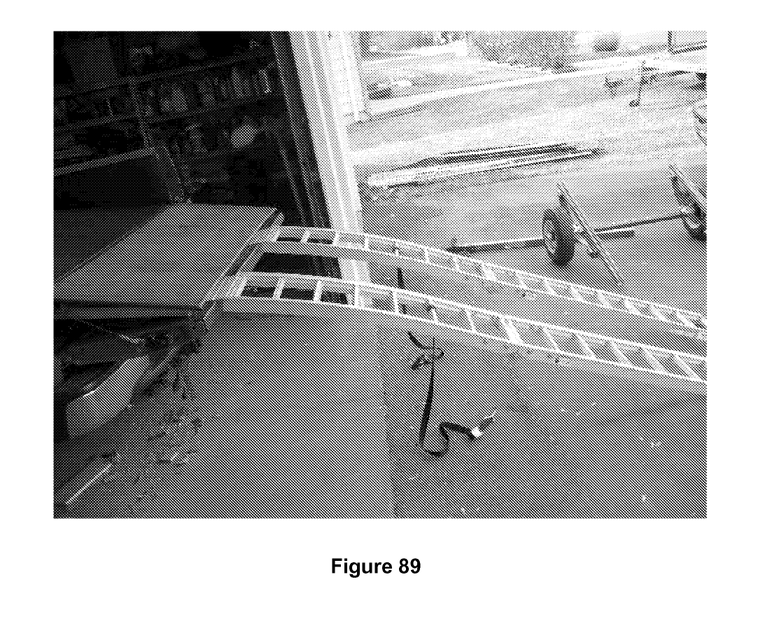

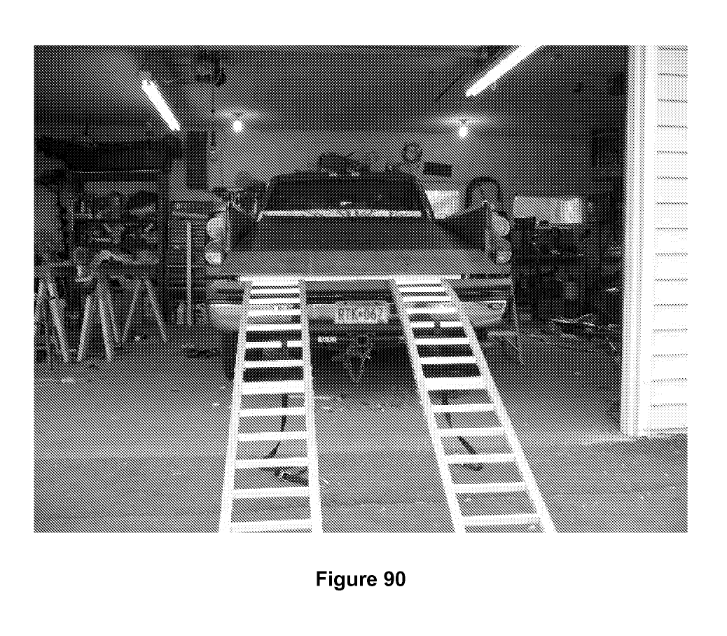

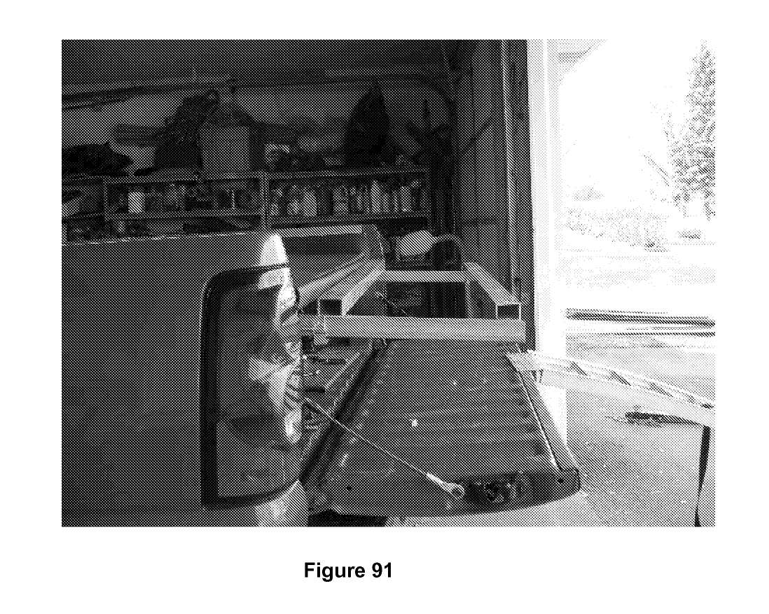

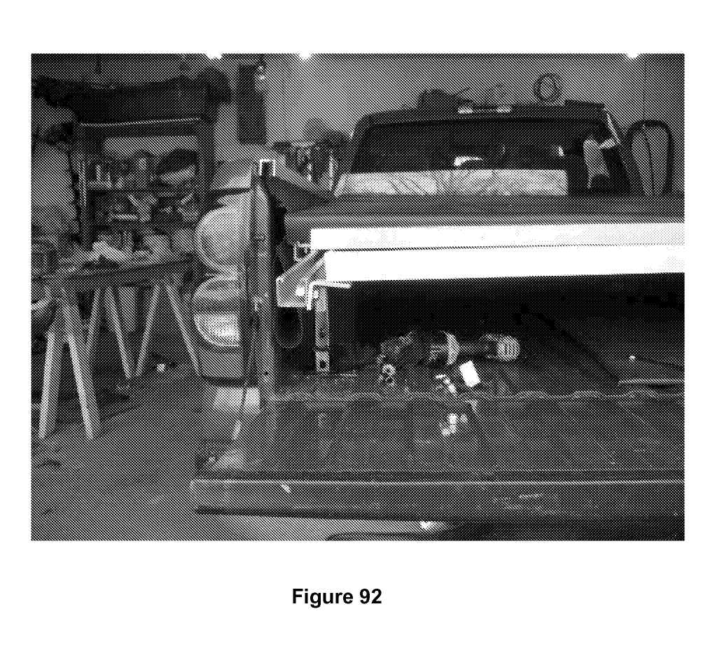

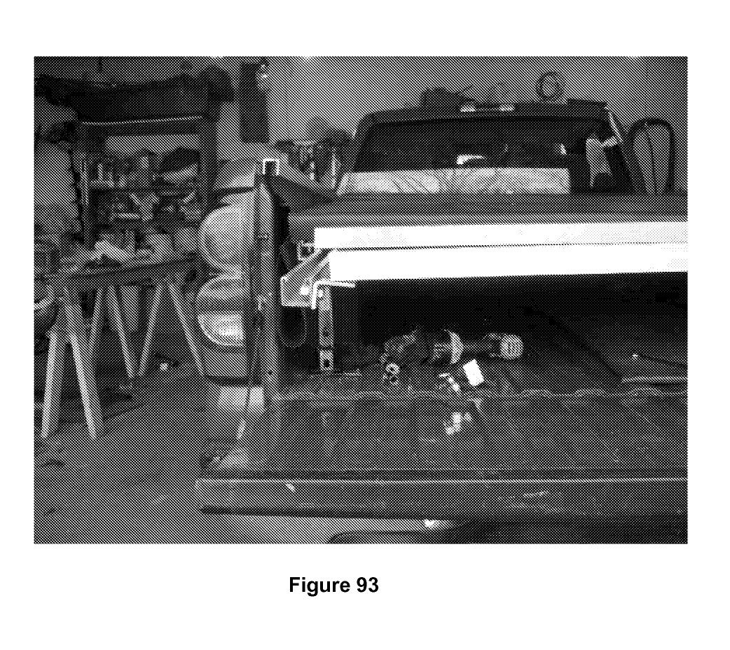

FIGS. 103-105 and 103B-105b depict other conceived configurations for bedrail assembly flanges 2, longitudinal channels 11, secondary channel 7, transverse support joists 4 and deck panels 13. They depict different integration schemes that may be used in future embodiments to improve configurability and weather resistance.

It should be noted that an alternate to adjustable jacks and/or in combination therewith, assistance in raising and lowering the cargo bed may be provided by way of a gas strut (like the ones used on car hoods, and mini van rear hatches) that could be used in conjunction with jacks to off set the weight of the deck and frame assembly. Further, a hydraulic ram or screw ram could also be used to raise lower deck assembly similar to those on car transport 18 wheelers.

In yet another embodiment of the present invention, the configurable cargo deck system in accordance with the present invention includes a primary support structure for quick and easy attachment to the truck rails, and secondary support structure interlocked with the primary support structure for enhancing the load capacity to more than 3000 pounds, and attachment of a wheel assembly thereto fro quick removal of the entire load and support structures, removed form attachment to the truck bed rails.

### Basic Support Structure With Top Panels

The basic topper uses a solid deck of wood, metal, composite, or plastic and is supported by 2 or more struts that are either one piece or a combination of telescoping tubes. The struts span the width of the truck box. The strut ends are supported by a metal rails clamped to each of the two long edges of truck box. The rails can be either metal tubing or metal angle member. When metal tubing is used, holes are machined into it in order to allow strut ends to fit into tubing. When a metal angle member is used struts can be bolted to the horizontal edge of the angle. The rails are secured to truck box with two or more adjustable clamps. Two (2) or more legs are positioned under each rail. Each leg is secured in place by using the adjustable clamp tightening bolt.

Each leg can be made of 1 piece or a combination of pieces being channel, square tubing, round tubing, rectangular tubing, unistrut channel or a channel similar to unistrut. Each leg could be a fixed length with or without a pad under it. The leg could be made to adjust with a screw type adjuster attached base of the leg or a separate foot made out of angle, or tubing bolted or screwed to the leg though a slotted hole. The base of leg or foot could be secured to truck bed with a bolt, a liquid adhesive with or without a rubber pad to prevent slipping or dampen vibration. The cargo deck is attached to the front and rear struts and include up to two doors adjacent to each longitudinal side of the box. The deck also lifts up at rear to access to covered load. This design allows the cover to be at a fixed height flush with top of truck box rail up to 300 lbs.

### 4 Wheeler Accessory to Carry Heavy Loads

In order to carry a load over 300 lbs a structural frame must be combined with the basic topper and its struts. It is comprised of two parallel rails made of structural channels (Un-istrut or similar), or tubing paralleling the long sides of truck box, four (4) or more automotive style jack stands, or camper stabilizer style jacks supporting the rails, two (2) trestles made of structural channel (unistrut or similar), or tubing attached perpendicularly near each end of rails and two pieces of angle approximately the same length of rails. The angles are supported at each end of the trestles. The angles provide support for the ends of the struts when deck is supported by the structural frame. The trestles attach to rails and provide a means to adjust the distance between rails. The rails contain individual pieces of square tubing attached to the top surface of rails provide support under cargo deck and are spaced apart to provide a pocket to key the basic topper's struts in order to prevent the cargo deck from shifting forwards and backwards while truck is in motion. The structural frame is secured to truck box with bolts or, or strapped to manufacture's truck box tie down loops and/or the legs used in the basic model. By adjusting the width of rails, support can be positioned under the cargo deck in various locations such as where an A T V 's tires would contact cargo deck. When using the load carrying structural frame, the basic model struts are retracted (UN pinned from square tubing) allowing the structural frame to carry most of the load. When not carrying a load the frame can be completely removed from truck box.

The flexible gutter that attaches to truck rail and frame for waterproofing may be a seal made of a flexible water proof material that attaches to truck bed rail, and with hook and loop is attached to frame to a bellows which will move with the frame when raised, lowered, and tilted as aforedescribed.

The foregoing has demonstrated the distinguishable features of the present invention for providing a configurable cargo system create that may be in a first embodiment mounted directly to the side truck rails of a truck cargo bed for providing a structurally sound cargo bed while at the same time providing a waterproof cargo area beneath the cargo deck of the configurable cargo deck assembly. In the second embodiment, the cargo assembly may be supported by support jack posts that may be adjusted as desired to create a cargo bed as desired, and be locked in place as desired while maintaining the waterproof integrity of the cargo space beneath the cargo deck assembly. Further a trailer wheel assembly may be easily coupled the cargo deck assembly as desired to provide the many salient features as described, particularly the convertible trailer/support platform.

I claim:

1. A convertible and configurable cargo system for integration with a pick-up truck bed comprising:
a plurality of panels sufficient to cover the area of the pick-up truck bed;
a cargo assembly frame including a plurality of longitudinal supports aligned with the side rails of the truck, and transverse joists forming a grid to support plurality of panels; and
clamping means for selectively clamping outer longitudinal supports to the truck side rails.

2. The convertible and configurable cargo system of claim 1 further comprising a wheel assembly including a pair of spaced apart wheels removably attached to said cargo assembly frame permitting said cargo assembly to be wheeled off said pick-up truck bed as a unit when released from.

3. The convertible and configurable cargo system of claim 1 further comprising a mating support structure with said first cargo assembly frame for enhancing the load capacity of the combination of the cargo assembly frame assembly, panels and mating support structure.
